(19) United States
(12) Patent Application Publication
(10) Pub. No.: US 2024/0061165 A1
(43) Pub. Date: Feb. 22, 2024

(54) LIGHT GUIDE ELEMENT AND DISPLAY APPARATUS USING THE SAME

(71) Applicant: AGC Inc., Tokyo (JP)

(72) Inventors: Motoshi NAKAYAMA, Fukushima (JP); Mitsuo OSAWA, Tokyo (JP)

(73) Assignee: AGC Inc., Tokyo (JP)

(21) Appl. No.: 18/384,838

(22) Filed: Oct. 28, 2023

Related U.S. Application Data
(63) Continuation of application No. PCT/JP22/18697, filed on Apr. 25, 2022.

(30) Foreign Application Priority Data
May 7, 2021 (JP) 2021-079180

(51) Int. Cl. F21V 8/00; G02B 27/01

(52) U.S. Cl. CPC G02B 6/0016; G02B 6/0036; G02B 6/0065; G02B 27/0172

(57) ABSTRACT

A light guide element includes a light guide substrate that is a single-layer light guide substrate; and a diffraction layer formed on the light guide substrate. The diffraction layer includes a first diffraction grating configured to in-couple light into the light guide substrate; and a second diffraction grating configured to outcouple totally internally reflected light having propagated in the light guide substrate out of the light guide substrate. The first diffraction grating in-couples the incident light in a range of 60 degrees or more including a direction normal to substrate, for at least one of first wavelength of 450 nm±20 nm, second wavelength of 530 nm±20 nm, and third wavelength of 630 nm±20 nm. The second diffraction grating outcouples the totally internally reflected light in a range of 60 degrees or more including the direction normal to substrate, for at least one of the first, second, and third wavelengths.

### CROSS-REFERENCE TO RELATED APPLICATION

The present application is a continuation application of International Application No. PCT/JP2022/018697, filed Apr. 25, 2022, which claims priority to Japanese Patent Application No. 2021-079180 filed May 7, 2021. The contents of these applications are incorporated herein by reference in their entirety.

### BACKGROUND OF THE INVENTION

### 1. Field of the Invention

The disclosure herein generally relates to a light guide element, and a display apparatus using the same.

### 2. Description of the Related Art

Augmented Reality (AR)/Mixed Reality (MR) headsets for personal use or professional use have been developed. Because the ARMR headset is required to have high resolution and a wide viewing angle, a heavy member is often used for a member for displaying an ARMR image. Thus, an entire headset is also heavy and wearing feeling is not good because the headset is fixed to the head. On the other hand, small and light-weight glasses-type displays that display simple information such as characters and symbols have also been developed.

An optical element for displaying ARMR images used in a personal display or an augmented reality display has been known having a configuration in which a projected image from a projector is displayed in front of the eyes using a diffracted light guide, in which an input coupling grating, an exit pupil expansion grating, and an output coupling grating are formed on a light guide plate (See, for example, Japanese translation of PCT international application publication No. 2020-521994 and Japanese translation of PCT international application publication No. 2017-528739). As optical glass used for the light guide plate, lead-free and arsenic-free optical glass with the refractive index nd to the d-line of greater than or equal to 1.91 and less than or equal to 2.05 is known (for example, see Japanese Patent No. 4970896).

### SUMMARY OF THE INVENTION

### Problem to be Solved by the Invention

If a light-weight display apparatus with the same function and the wide viewing angle as those of the ARMR headset is achieved, the application field and the user range would be further expanded. The present invention aims at providing a light guide element with light-weight and a wide viewing angle, and a display apparatus using the same.

### Means for Solving the Problem

According to an aspect of the present disclosure, a light guide element includes a light guide substrate that is a single-layer light guide substrate; and a diffraction layer formed on the light guide substrate. The diffraction layer includes a first diffraction grating configured to in-couple light into the light guide substrate, the light being incident on the light guide substrate; and a second diffraction grating configured to outcouple totally internally reflected light having propagated in the light guide substrate out of the light guide substrate. The first diffraction grating in-couples the incident light in a range of 60 degrees or more including a direction normal to the light guide substrate, for at least one wavelength of a first wavelength included in a 450 nm±20 nm band, a second wavelength included in a 530 nm±20 nm band, and a third wavelength included in a 630 nm±20 nm band. The second diffraction grating outcouples the totally internally reflected light in a range of 60 degrees or more including the direction normal to the light guide substrate, for at least one wavelength of the first wavelength, the second wavelength, and the third wavelength.

### Effect of the Invention

According to the invention of the present application, a light guide element with low weight and a wide viewing angle, and a display apparatus using the same can be provided.

### BRIEF DESCRIPTION OF THE DRAWINGS

Other objects and further features of the present disclosure will be apparent from the following detailed description when read in conjunction with the accompanying drawings, in which:

FIG. 1 is a diagram schematically showing an example of a configuration of a light guide element according to an embodiment of the present application;

FIG. 2A is a diagram showing a coupling of light to a light guide substrate, the light being incident on the light guide substrate, by an in-coupling grating;

FIG. 2B is a diagram showing totally internally reflected guided light from the in-coupling grating to an outcoupling grating;

FIG. 2C is a diagram showing emission of light from the outcoupling grating to the outside of the light guide substrate;

FIG. 2D shows examples of compositions with refractive indices for the d-line greater than 2.05;

FIG. 3 is a diagram depicting an example of a display apparatus using the light guide element according to the embodiment of the present application;

FIG. 4 is a diagram showing an example of an operation of the light guide element used in the display apparatus;

FIGS. 5A and 5B are diagrams showing an example of a configuration of a light guide element using a line-and-space type one-axis diffraction grating;

FIGS. 6A to 6C are diagrams showing an example of a configuration of a light guide element using a two-axis diffraction grating, in which a unit grating is a rectangular grating, for the outcoupling grating;

FIGS. 7A to 7D are diagrams showing an example of a configuration of a light guide element using a two-axis diffraction grating, in which a unit grating is a rectangular grating for both the in-coupling grating and the outcoupling grating;

FIG. 8 shows shapes of the grating and optical characteristics of practical examples and comparative examples;

FIG. 9 shows an example of materials for the light guide substrate;

FIG. 10 shows differences in refractive index between the light guide substrate and the diffraction layer in the practical examples and the comparative examples;

FIG. 11 shows properties of materials used for the diffraction layer;

FIGS. 12A and 12B are diagrams illustrating an example of designing a NA (Numerical Aperture) diagram and a FOV (Field of View);

FIGS. 13A and 13B are diagrams illustrating another example of designing the NA diagram and the FOV;

FIGS. 14A and 14B are diagrams illustrating yet another example of designing the NA diagram and the FOV;

FIGS. 15A and 15B are diagrams illustrating positive and negative one-dimensional diffraction guiding directions and visibility;

FIG. 16 is a diagram illustrating an FOV expansion effect by using positive and negative one-dimensional diffractions;

FIGS. 17A and 17B are diagrams illustrating an effect when the in-coupling grating is a two-axis diffraction grating;

FIG. 18A is a diagram illustrating an effect when a rectangular grating is employed for the unit grating;

FIG. 18B is a diagram illustrating an example of an FOV light guide when a square grating is employed for the unit grating;

FIG. 18C is a diagram illustrating another example of an FOV light guide when a square grating is employed for the unit grating;

FIG. 19A is a diagram illustrating characteristics of an RGB light guide in Example 1 (upper), and diffraction patterns thereof (middle and lower);

FIG. 19B is a diagram illustrating characteristics of a G light guide in Example 1 (upper), and diffraction patterns thereof (middle and lower);

FIG. 20A is a diagram illustrating characteristics of an RGB light guide in Example 2 (upper), and diffraction patterns thereof (middle and lower);

FIG. 20B is a diagram illustrating characteristics of a G light guide in Example 2 (upper), and diffraction patterns thereof (middle and lower);

FIG. 21A is a diagram illustrating characteristics of an RGB light guide in Example 3 (upper), and diffraction patterns thereof (middle and lower);

FIG. 21B is a diagram illustrating characteristics of a G light guide in Example 3 (upper), and diffraction patterns thereof (middle and lower):

FIG. 22A is a diagram illustrating characteristics of an RGB light guide in Example 4 (upper), and diffraction patterns thereof (middle and lower); and

FIG. 22B is a diagram illustrating characteristics of a G light guide in Example 4 (upper), and diffraction patterns thereof (middle and lower).

### DESCRIPTION OF THE EMBODIMENT

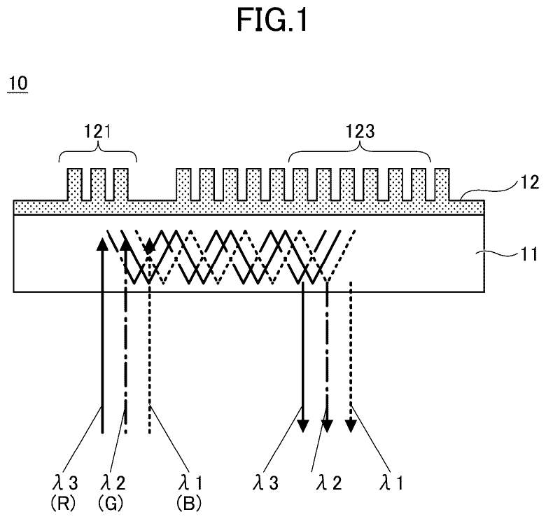

FIG. 1 is a diagram schematically illustrating an example of a configuration of a light guide element 10 according to an embodiment. The light guide element 10 has a light guide substrate 11 that is a single-layer light guide substrate, and a diffraction layer 12 formed on the light guide substrate 11. The diffraction layer 12 has an in-coupling grating 121 for coupling light into the light guide substrate 11, the light being incident on the light guide substrate 11, and an outcoupling grating 123 for emitting totally internally reflected light propagating in the light guide substrate 11 out of the light guide substrate 11. As described later, an extended grating for guiding the light in-coupled into the light guide substrate 11 to the outcoupling grating 123 may be formed on the light guide substrate 11. The light incident direction and the light emitting direction are not limited to the rear surface of the light guide substrate 11. The light incident from the surface where the diffraction layer 12 is formed can be coupled into the light guide substrate 11. Light can be outcoupled from the surface where the diffraction layer 12 is formed. The diffraction layer 12 may be formed only on one surface of the light guide substrate 11, or may be formed on both surfaces thereof.

In the embodiment, using the light guide substrate 11 that is a single-layer light guide substrate, light of a first wavelength included in the blue wavelength band, light of a second wavelength included in the green wavelength band, and light of a third wavelength included in the red wavelength band are taken into the light guide substrate 11 in a high FOV (field of view), and emitted from the light guide substrate 11 in a high FOV. The blue wavelength band is a range of, for example, 450 nm±20 nm. The green wavelength band is a range of, for example, 530 nm±20 nm. The red wavelength band is a range of, for example, 630 nm±20 nm.

Specifically, incident light is in-coupled in a range of 60 degrees or more, preferably 65 degrees or more, and more preferably 70 degrees or more, including the direction normal to the light guide substrate 11 for any one wavelength of the first wavelength (λ1), the second wavelength (λ2), and the third wavelength (λ3). The light is also outcoupled out of the light guide substrate 11 in a range of 60 degrees or more, preferably 65 degrees or more, and more preferably 70 degrees or more, including the direction normal to the light guide substrate 11 for any one wavelength of λ1, λ2, and λ3. The angle formed by the central direction of the angular range of the light to be in-coupled or the outcoupled light and the direction normal to the substrate is preferably 15 degrees or less, more preferably 10 degrees or less, even more preferably 5 degrees or less, and most preferably approximately 0 degrees (the central direction coincides with the direction normal to the substrate).

Furthermore, the in-coupling grating 121 in-couples incident light of any of the wavelengths of λ1, λ2, and λ3 in a common angular range of 55 degrees or more, including the direction normal to the light guide substrate 11. The outcoupling grating 123 outcouples light of any of the wavelengths of λ1, λ2, and λ3 in a common angular range of 55 degrees or more, including the direction normal to the light guide substrate 11. The angle formed by the central direction of the angular range of the light to be in-coupled or the outcoupled light and the direction normal to the substrate is preferably 15 degrees or less, more preferably 10 degrees or less, even more preferably 5 degrees or less, and most preferably approximately 0 degrees (the central direction coincides with the direction normal to the substrate).

In other words, the above descriptions are expressed as follows. The angular range of the light to be in-coupled or the outcoupled light preferably includes a range of at least −42.5 degrees to +12.5 degrees with respect to the direction normal to the substrate, or a range of −12.5 degrees to +42.5 degrees; more preferably a range of at least −37.5 degrees to +17.5 degrees, or a range of −17.5 degrees to +37.5 degrees; even more preferably a range of at least −32.5 degrees to +22.5 degrees or −22.5 degrees to +32.5 degrees; and most preferably a range of at least −27.5 degrees to 27.5 degrees. That is, preferably a fluctuation in the angular range is 15 degrees or less, more preferably 10 degrees or less, even more preferably 5 degrees or less, and most preferably the fluctuation in the angular range is approximately zero.

In the conventional configuration, monochromatic light guide plates respectively corresponding to the wavelengths are used in 3 layers. In this case, the FOV can be optimized for each wavelength, and a high FOV can be easily achieved. However, an entire optical element becomes thick and heavy. In the embodiment of the present application, because RGB light is guided by the light guide substrate 11 that is a single-layer light guide substrate, a compact and light-weight light guide element 10 can be achieved. When a light guide substrate 11 that is a single-layer light guide substrate is used, a FOV that each FOV of the wavelength of RGB overlaps is an entire FOV. In the present application, a high FOV is achieved by improving materials of the light guide substrate 11 and the diffraction layer 12, and designs of the in-coupling grating 121 and the outcoupling grating 123. For example, both the light guide substrate 11 and the diffraction layer 12 are formed of inorganic materials, and each of the substrate and the layer is designed to have a predetermined refractive index. In addition, the positive and negative one-dimensional diffractions are used. Bases of the configuration and results of analysis will be described later.

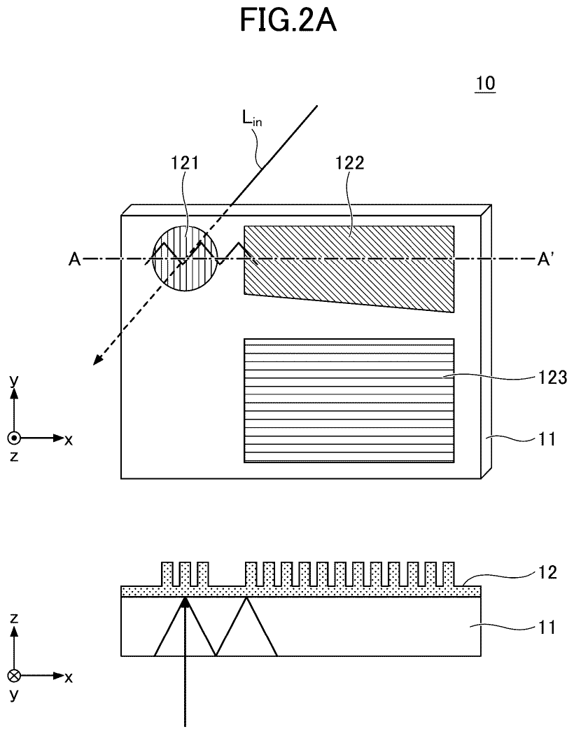

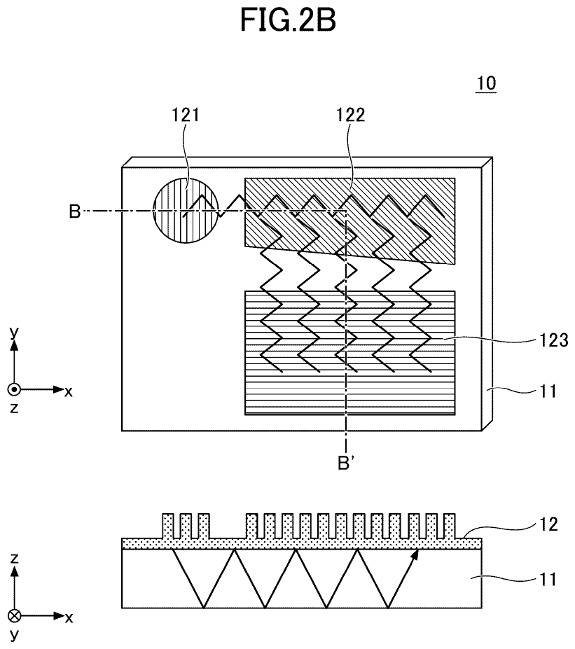

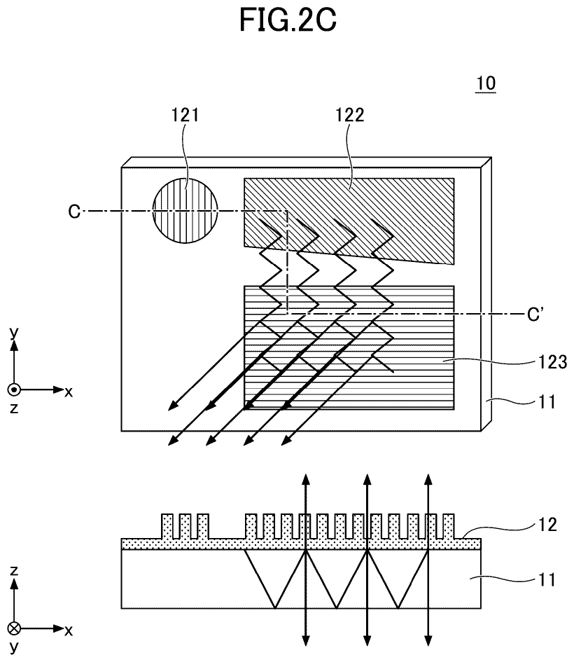

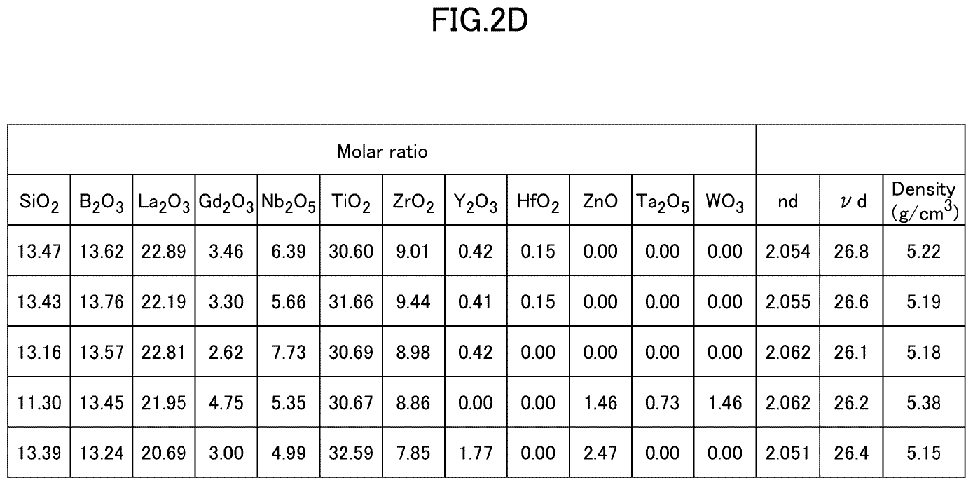

FIG. 2A is a diagram illustrating the coupling of light Lin into the light guide substrate 11, the light being incident on the light guide substrate 11, by an in-coupling grating 121. A surface where the diffraction layer 12 is formed on the light guide substrate 11 is defined to be an x-y plane, and the thickness direction of the light guide substrate 11 is defined to be a z-direction. FIG. 2A shows the configuration on the x-y plane (upper), and a cross section cut along the line of A-A′ (lower). Light of each wavelength of RGB is incident on the light guide element 10. Note that the wavelength is not distinguished in FIG. 2A for convenience of illustration.

The light Lin is coupled into the light guide substrate 11, the light being incident on the light guide substrate, by the in-coupling grating 121 as a diffraction wavefront in a predetermined direction, e.g., the x-direction. The direction in which the light Lin is coupled into the light guide substrate 11, the light being incident on the light guide substrate, is not limited to the +x-direction. As described later, a configuration in which the light into the light guide substrate propagates in the +x-direction may be adopted, or a configuration in which the light into the light guide substrate propagates in the two-dimensional directions of the x and y-directions may be adopted. The in-coupling grating 121 couples light incident from the diffraction layer 12 side as well as light incident from the rear surface side of the light guide substrate 11 into the light guide substrate 11. Perpendicular incident light incident in the direction normal to the light guide substrate 11 is also coupled into the light guide substrate 11. In addition, the FOV of 55 degrees or more is achieved for all wavelengths of RGB.

FIG. 2B is a diagram illustrating a totally internally reflected guided light from the in-coupling grating 121 to the outcoupling grating 123. FIG. 2B shows the configuration on the x-y plane (upper), and a cross section cut along the line of B-B′ (lower). The propagation direction of the light in-coupled into the light guide substrate 11 is converted by an extended grating 122. The extended grating 122 has a line-and-space pattern extending obliquely with respect to an x-axis or a y-axis. The extended grating 122 diffracts a part of light into the −y-direction while guiding most of light into the x-direction. According to the line-and-space pattern of the extended grating 122, a number of diffracted light beams are replicated along the x-direction, and each diffracted light beam propagates in the −y-direction. The propagating light beam in the x-direction as well as the diffracted light beam in the −y-direction propagate while totally internally reflecting in the light guide substrate 11.

FIG. 2C is a diagram illustrating emission of light from the outcoupling grating 123 to the outside. FIG. 2C shows the configuration on the x-y plane (upper), and a cross section cut along the line of C-C′ (lower). The outcoupling grating 123 diffracts and emits a part of light while guiding most of light by total internal reflection. According to the outcoupling grating 123, a plurality of diffracted light beams are emitted to the outside of the light guide substrate 11 while being replicated along the light guiding direction. Because the light can be emitted from the diffraction layer 12 side as well as from the rear surface side of the light guide substrate 11, an image formed by the emitted light can be seen from either side.

The outcoupling grating 123 emits the light which is guided by total internal reflection inside the light guide substrate 11 in a predetermined angular range including the direction normal to the light guide substrate 11. Specifically, the outcoupling is achieved in the FOV of 60 degrees or more including the direction normal to the light guide substrate for any one of the wavelengths of RGB. The outcoupling is also achieved in the FOV of 55 degrees or more including the direction normal to the light guide substrate for all the wavelengths of RGB.

### <Material for Light Guide Substrate>

FIGS. 2A to 2C illustrate that in the light guide substrate 11 in-coupled light propagates by total internal reflection to the outcoupling position. The higher the refractive index of the light guide substrate 11, the greater the angular range in which the totally internally reflected light can be guided. The refractive index nd for the d-line (wavelength is 587.56 nm) of the light guide substrate 11 is greater than 2.05 (nd>2.05). Glass compositions with the refractive index nd for the d-line greater than 2.05 include, for example, compositions shown in FIG. 2D. When the refractive index nd is greater than 2.08, it becomes easier to design the substrate with a higher FOV. Moreover, in order to outcouple incident light with minimal loss, an internal transmittance for any of the wavelengths λ1, λ2 and λ3 is preferably high. Because short-wavelength light has a greater transmittance loss due to absorption, the internal transmittance per 10 mm thickness of the light guide substrate 11 in light with a wavelength of 450 nm may be set to be 90% or more, and more preferably 95% or more. The glass compositions in which the internal transmittance of the light guide substrate 11 in light with a wavelength of 450 nm is 95% or more include, for example, a composition shown in TABLE 1.

TABLE 1
Molar ratio

| | | | | | | | Internal |
|---|---|---|---|---|---|---|---|
| Bi₂O₃ | B₂O₃ | TeO₂ | P₂O₅ | Nb₂O₅ | ZnO | TiO₂ | transmittance |
| 29.9 | 17.8 | 27.4 | 10.3 | 5.6 | 9.0 | 0.0 | 95.5% |

The light guide substrate 11 is, for example, a glass substrate. As the glass material, (1) Bi₂O₃—TeO₂ based glass or (2) La₂O₃—B₂O₃ based glass may be used. In the specification of the present application, “composition” refers to a composition of elements or components designed to be 100% in total, in the unit of percent (mole %, weight %, or the like), excluding impurities that are inevitably mixed, or impurities and additives in parts per million (ppm) units that are intentionally added.

Examples of Bi₂O₃—TeO₂ based glass include glass with a Bi₂O₃ content of 20% to 50% and a TeO₂ content of 10% to 35%, when the total composition is 100% by mole % in terms of oxide.

Bismuth oxide, Bi₂O₃, is a preferred component to obtain high refractive index glass with high visible light transmittance. A lower limit of a content thereof is preferably 20% or more, and more preferably 25% or more, and even more preferably 30% or more. An upper limit of the content is preferably 45% or less, more preferably 40% or less, and even more preferably 35% or less.

Tellurium dioxide, TeO₂, is a glass-forming component and may be contained in glass because TeO₂ enables obtainment of a high refractive index glass with high visible light transmittance. A content of TeO₂ is preferably 10% or more, more preferably 20% or more, and even more preferably 25% or more. However, the content of TeO₂ is preferably 35% or less, and more preferably 30% or less, because excessive content thereof makes the glass unstable.

Boron oxide, B₂O₃, is a glass-forming component, and is preferably contained to stabilize glass. However, an excessive content thereof makes it difficult to achieve a high refractive index. A lower limit of the content is preferably 10% or more, and more preferably 12% or more. An upper limit of the content is preferably 40% or less, more preferably 35% or less, further more preferably 30% or less, and even more preferably 25% or less.

Diphosphorus pentoxide, P₂O₅, is an optional component. P₂O₅ is a glass-forming component, and is preferably contained to stabilize glass. However, an excessive content thereof makes it difficult to achieve a high refractive index. A lower limit of the content is preferably 0% or more, and an upper limit of the content is preferably 20% or less, and more preferably 15% or less.

A lower limit of a sum of the B₂O₃ content and the P₂O₅ content is preferably 10% or more, and more preferably 20% or more. An upper limit of the sum is preferably 45% or less, more preferably 40% or less, and more preferably 35% or less.

Niobium oxide, Nb₂O₅, titanium oxide, TiO₂, tantalum oxide, Ta₂O₅, and tungsten oxide, WO₃, are preferred components to be contained to enhance the refractive index of the glass. These components, including Bi₂O₃ and TeO₂, are components that can be also used as the diffraction layer 12 described later. By increasing the content of these components, a configuration having a dispersion relation of the refractive index close to that of the diffraction layer 12 can be achieved. The content of Bi₂O₃—TeO₂—Nb₂O₅—TiO₂—Ta₂O₅—WO₃ is preferably higher. The content is preferably 55% or more, and more preferably 60% or more.

Examples of La₂O₃—B₂O₃ based glass include glass with a La₂O₃ content of 10% to 40% and a B₂O₃ content of 10% to 35%, when the total composition is 100% by mole % in terms of oxide.

Lanthanum oxide, La₂O₃, has an excellent function of increasing the refractive index and decreasing the dispersion while maintaining the stability of the glass, is a component with a high visible light transmittance, and can provide high refractive index glass with high visible light transmittance. Therefore, La₂O₃ may be contained in the glass, but an excessive content makes the devitrification resistance decrease. A lower limit of the content is preferably 10% or more, and more preferably 20% or more. An upper limit of the content is preferably 40% or less, more preferably 30% or less, and even more preferably 25% or less.

Boron oxide, B₂O₃, is a glass-forming component, and is preferably contained to stabilize glass. However, an excessive content thereof makes it difficult to achieve a high refractive index. A lower limit of the content is preferably 10% or more, and more preferably 12% or more. An upper limit of the content is preferably 40% or less, more preferably 35% or less, further more preferably 30% or less, and even more preferably 25% or less.

Silicon dioxide, SiO₂, is an optional component. SiO₂ is a glass-forming component and may be included to stabilize the glass, but an excessive content makes it difficult to achieve a high refractive index. A lower limit of the content is preferably 0% or more, more preferably 5% or more, and even more preferably 10% or more. An upper limit of the content is preferably 30% or less, more preferably 20% or less, and even more preferably 15% or less.

Titanium oxide, TiO₂, has an excellent function of increasing the refractive index while maintaining the stability of the glass, and may be contained in the glass. However, an excessive content makes the devitrification resistance decrease. A lower limit of the content is preferably 10% or more, more preferably 20% or more, and even more preferably 25% or more. An upper limit of the content is preferably 40% or less, and more preferably 35% or less.

Zirconium oxide, ZrO₂, is an optional component. ZrO₂ has an excellent function of increasing the refractive index while maintaining the stability of the glass, and may be contained in the glass. However, an excessive content makes the devitrification resistance decrease. A lower limit of the content is preferably 0% or more, and more preferably 5% or more. An upper limit of the content is preferably 15% or less, and more preferably 10% or less.

Gadolinium oxide, Gd₂O₃, niobium oxide, Nb₂O₅, tantalum oxide, Ta₂O₅, and tungsten oxide, WO₃, are preferred components to be contained to enhance the refractive index of the glass. These components, including La₂O₃ and TiO₂, are components which can also be used as the diffraction layer 12 described later. By increasing the content of these components, a configuration having a dispersion relation of the refractive index close to that of the diffraction layer 12 can be achieved. The content of La₂O₃—TiO₂—Gd₂O₃—N_{b2}O₅—Ta₂O₅—WO₃ is preferably higher. The content is preferably 55% or more, and more preferably 60% or more. Furthermore, ZrO₂ may be included, and the content of La₂O₃—TiO₂—Gd₂O₃—Nb₂O₅—Ta₂O₅—WO₃—ZrO₂ is preferably 55% or more, and more preferably 60% or more.

Using the glass material having the above-described composition, the light guide substrate 11 with a refractive index to the d-line (λ2) exceeding 2.05 or the light guide substrate 11 with an internal transmittance per 10 mm thickness at 450 nm of 95% or more can be achieved.

The light guide substrate 11 may be a single crystal substrate. A single crystal refers to a crystal in which an orientation of an arrangement of atoms or molecules is the same in any part of the crystal. The light guide substrate 11 may be an isotropic single crystal substrate having optical characteristics independent of an orientation of the crystal, or may be a uniaxial single crystal substrate having a crystal axis oriented in a predetermined direction. In the case of the uniaxial substrate, an angle formed by the optical axis of the light guide substrate 11 and the direction normal to the light guide substrate 11 is preferably within ±4 degrees, and more preferably within ±0.4 degrees. This is because a center of a line of sight, when viewing an actual scene or characters that is not an ARMR image through the light guide substrate, roughly coincides with the direction normal to the substrate, and an image is doubled due to birefringence when the optical axis deviates from the propagating direction of light, that leads to a reduction in resolution.

In crystals, lattice defects called dislocation defects sometimes occur. For example, near a dislocation defect called micropipe having a size larger than 1 μm in diameter, a change in the refractive index often occurs. Even if the size of the defect does not affect the appearance as a light guide element, in the case where such defects occur within the range of a light guide, the change in the refractive index may lead to a reduction in the resolution of an image displayed from the light guide element. Thus, the above-described defects are preferably not present in the light guide element. The defect density of the micropipe is preferably 10/cm² or less, more preferably 1/cm² or less, and even more preferably 0.1/cm² or less.

As the single-crystal light guide substrate 11, a substrate formed of TiO₂, SrTiO₃, KTaO₃, LiNbO₃, SiN, SiC, diamond, or the like may be used.

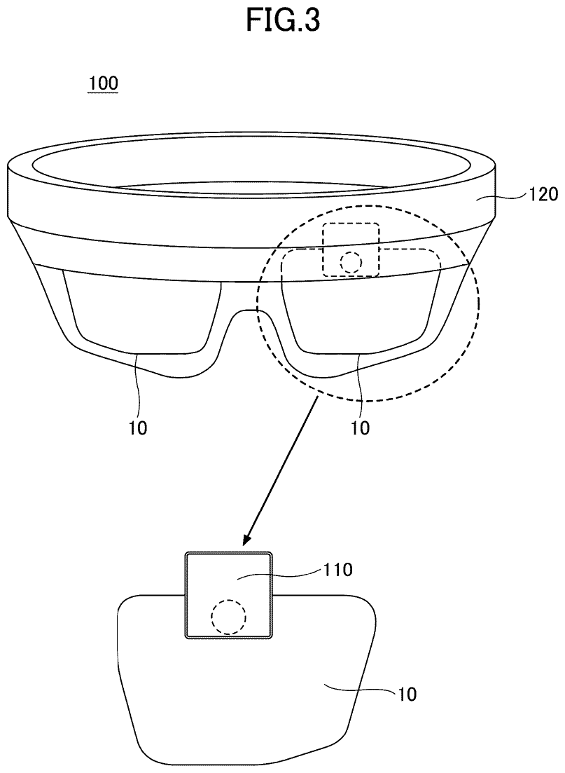

FIG. 3 shows an example of a display apparatus 100 using the light guide element 10 according to the embodiment. The display apparatus 100 is an ARMR goggle in this example. The light guide element 10 is used as an eyepiece for the right eye and an eyepiece for the left eye. The display apparatus 100 has the light guide element 10 and a projector 110. Each of the light guide elements 10 for the right and left eyes is provided with a projector 110. The light guide element 10 and the projector 110 are held by a wearable support 120. The light guide element 10 is formed of a light guide substrate 11 that is a single-layer light guide substrate, and the display apparatus 100 is small-size and light-weight as a whole.

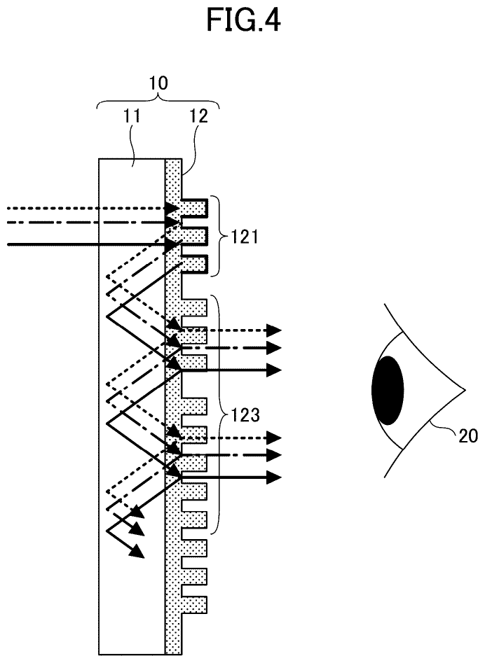

FIG. 4 shows an example of an operation of the light guide element 10 used in the display apparatus 100. An image projected from the projector 110 is diffracted into the light guide substrate 11 by the in-coupling grating 121. As described above, the in-coupling grating 121 diffracts RGB light into the inside of the light guide substrate 11 in the FOV of 55 degrees or more including normal incident light. The in-coupled RGB light propagates inside the light guide substrate 11 while being totally internally reflected, is diffracted by the outcoupling grating 123, and is emitted from the light guide substrate 11 in the FOV of 55 degrees or more. An image of this light enters human eye 20 and is recognized as a color image.

The thickness of the light guide substrate 11 is, for example, 1 mm or less. Each of the in-coupling grating 121 and the outcoupling grating 123 is, as an example, formed of a thin film of an inorganic material with a thickness of 100 to 1000 nm and has a diffraction grating pattern formed at a predetermined pitch. When the extended grating 122 is used in conjunction with the in-coupling grating 121 and the outcoupling grating 123, the extended grating 122 is also formed of the same thin film. The pitch of the diffraction grating is, for example, 300 to 500 nm. Instead of forming the diffraction layer 12 with a thin film of an inorganic material, the diffraction grating may be formed directly on the surface of the light guide substrate 11. In this case, the surface area where the diffraction grating is formed serves as the diffraction layer 12.

The in-coupling grating 121 achieves the FOV of more than 60 degrees, preferably more than 65 degrees, and more preferably more than 70 degrees for any one of the wavelengths of RGB. The in-coupling grating 121 achieves the FOV of more than 55 degrees for any of the wavelengths of RGB. The outcoupling grating 123 achieves the FOV of more than 60 degrees, preferably more than 65 degrees, and more preferably more than 70 degrees for any one of the wavelengths of RGB. The outcoupling grating 123 achieves the FOV of more than 55 degrees for any of the wavelengths of RGB.

The display apparatus 100 using the light guide element 10 may be configured to display color images in a range within the FOV of 55 degrees and to display simple information or monochromatic images in an area exceeding the FOV of 55 degrees. For example, simple information in letters and symbols, icons, toolbars, and the like may be displayed in an edge portion of the field of view. The display apparatus 100 may be provided with a cover covering a rear surface of the diffraction layer 12, a rear surface of the light guide substrate 11, or both. In that case, the cover may be a part of the light guide element 10 and held by the support 120 shown in FIG. 3. When the cover is used, the cover is preferably highly transparent to visible light and does not affect the light image emitted from the outcoupling grating 123. The material of the cover may be glass or plastic.

### <Configuration of Diffraction Grating>

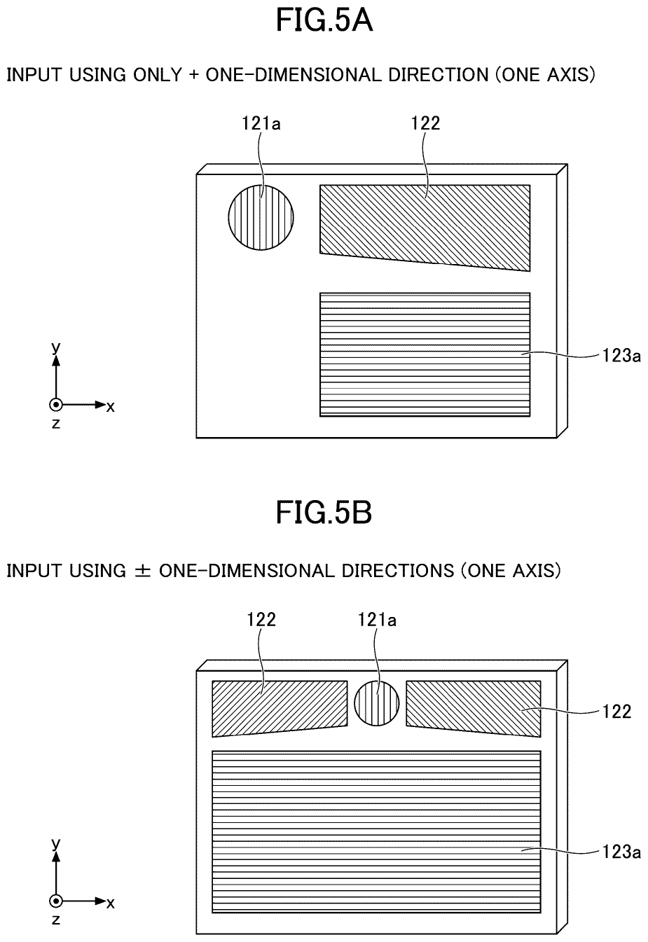

FIGS. 5A to 7D show examples of designs of the grating of the light guide element 10. FIGS. 5A and 5B show an example configuration in which both the in-coupling grating 121a and the outcoupling grating 123a have a line-and-space pattern that is a one-axis diffraction grating. FIG. 5A shows a configuration in which uniaxial diffraction, diffraction in the +x-direction in this example, is utilized in the in-coupling. As described with reference to FIGS. 2A to 2C, the RGB light diffracted in the +x-direction by the in-coupling grating 121a is redirected in the −y-direction by the extended grating 122, and emitted from the outcoupling grating 123 in the FOV of 55 degrees or more. Focusing on one of the wavelengths of the RGB light, the light is emitted in the FOV of 60 degrees or more, preferably 65 degrees or more, and even more preferably 70 degrees or more.

In the configuration shown in FIG. 5B, diffractions in the positive direction and negative direction along one axis is used in the in-coupling. In this example, diffraction in the ±x-directions is used in the in-coupling. The in-coupling grating 121a bifurcates incident light into two diffraction wavefronts and diffracts in the +x-direction and the −x-direction. Each of the diffracted light in the +x-direction and the −x-direction is redirected by the extended grating 122 and outcoupled by the outcoupling grating 123. The FOV of the emitted light is 55 degrees or more for all wavelengths of RGB. When focusing on any one of the wavelengths, the FOV of the emitted light is 60 degrees or more, preferably 65 degrees or more, and more preferably 70 degrees or more.

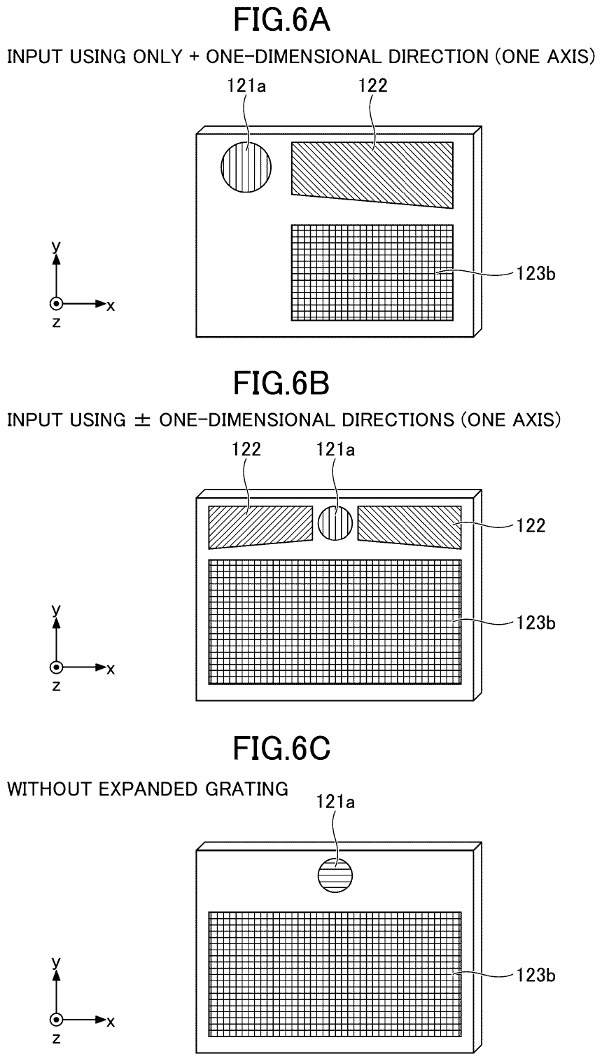

FIGS. 6A to 6C show an example in which a line-and-space pattern, which is a one-axis diffraction grating, is used for the in-coupling grating 121a, and the outcoupling grating 123b is a two-axis diffraction grating, in which the unit grating is a rectangular grating. Configurations shown in FIGS. 6A and 6B are the same as those shown in FIGS. 5A and 5B, respectively, except that the unit grating of the outcoupling grating 123b is a rectangular grating. By using a rectangular grating for the unit grating, an occurrence of vignetting can be suppressed as described later. “Vignetting” refers to a phenomenon that a part of a field of view to be displayed in an input image is lost due to local decrease in light or brightness, and occurs when the light of a part of the field of view cannot be guided with total internal reflection upon subjected to diffraction guiding through the light guide substrate.

FIG. 6C shows an example of a configuration in which the extended grating 122 is not present. The line-and-space pattern of the in-coupling grating 121a extends along the x-direction. The in-coupling grating 121a diffracts incident light into the ±y-directions. In this example, the diffraction in the −y-direction is used. The light in-coupled to the light guide substrate 11 propagates in the −y-direction while totally internally reflecting inside the light guide substrate 11, and is emitted to the outside of the light guide substrate 11 by the outcoupling grating 123b. In this case, because the extended grating 122 is not present, it is necessary to replicate the outcoupling light in two-dimensional directions by the outcoupling grating 123b to increase the visibility. Therefore, the outcoupling grating 123b is formed by a two-axis diffraction grating, in which the unit grating is a rectangular grating. The propagating light is diffracted in two dimensions.

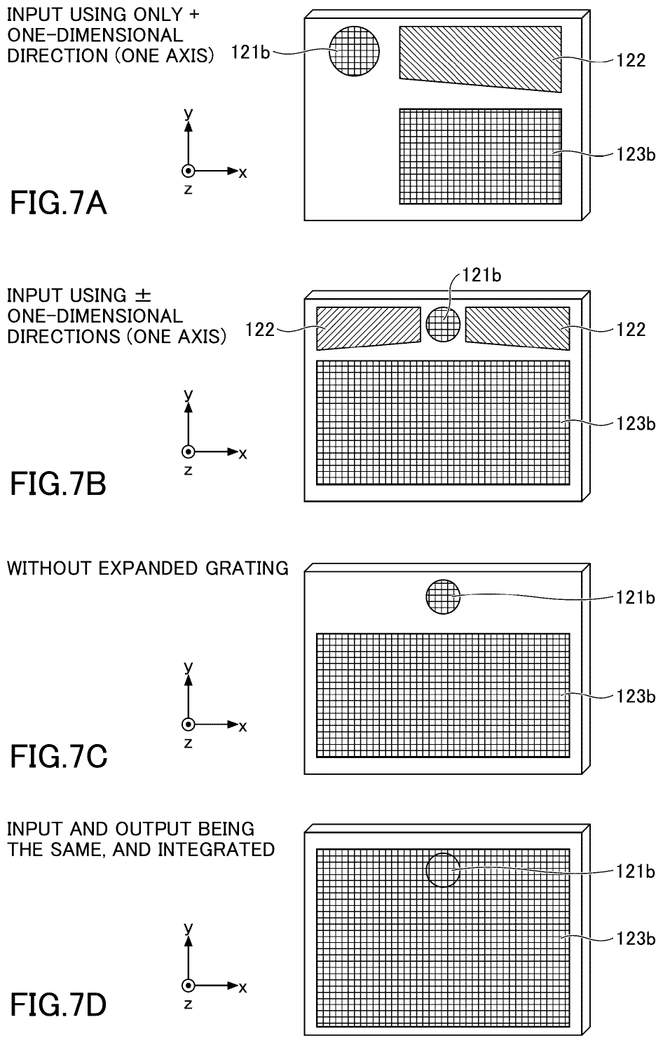

FIGS. 7A to 7D show an example of using a rectangular grating for the unit grating for both the in-coupling grating 121b and the outcoupling grating 123b. Configurations shown in FIGS. 7A, 7B, and 7C are the same as those shown in FIGS. 6A, 6B, and 6C, respectively, except that the unit grating of the in-coupling grating 121b is a rectangular grating. By using a rectangular grating for both the in-coupling grating 121b and the outcoupling grating 123b, it becomes possible to enlarge the FOV for the RGB guiding.

FIG. 7D shows an example of a configuration in which the in-coupling grating 121b and the outcoupling grating 123b partially overlap. A portion of the rectangular grating pattern of the outcoupling grating 123b functions also as the in-coupling grating 121b. An area in the outcoupling grating 123b that can be in-coupled in the FOV of 55 degrees or more for light for each of the wavelengths of RGB emitted from the projector 110 (see FIG. 3) serves as the in-coupling grating 121b.

The light guide element 10 may adopt any configuration of the grating shown in FIG. 5A to FIG. 7D. Regardless of which configuration is adopted, the refractive index of the diffraction layer 12 is preferably the same as the refractive index of the light guide substrate 11 or higher than the refractive index of the light guide substrate 11. As described later, for each wavelength of RGB, a difference between the refractive index of the diffraction layer 12 and the refractive index of the light guide substrate 11 is preferably 0.1 or less.

The diffraction layer 12 including the in-coupling grating 121 and the outcoupling grating 123 is formed of, for example, ZrO₂, HfO₂, Ta₂O₅, Nb₂O₅, TeO₂, MoO₃, WO₃, TiO₂, SiN, SiON, SnO, ITO (indium tin oxide), Al₂O₃, Y₂O₃, AlN, MgO, or a mixture of two or more of the above-described compounds. Alternatively, the diffraction layer 12 may be formed of a glass material containing three or more inorganic elements. The diffraction layer 12 may be deposited on the surface of the light guide substrate 11 by vapor deposition, sputtering, or the like. The in-coupling grating 121, the extended grating 122, and the outcoupling grating 123 are formed by forming desired patterns on the diffraction layer 12 by etching, such as a line-and-space pattern, a rectangular grating pattern, or the like.

When the diffraction layer 12 is formed with a mixture of two or more of the above-described compounds, a film may be formed by co-sputtering to match the dispersion of the refractive index, that is, the wavelength dependence of the refractive index to that of the light guide substrate 11. The diffraction layer 12 may be formed by etching or by a lift-off method. As the diffraction layer 12, a diffraction grating may be carved directly into a glass substrate, a single crystal substrate, or the like. In this case, the light guide substrate 11 and the diffraction layer 12 can be formed integrally with a high-refractive-index material. When the light guide element 10 is applied to the display apparatus 100 shown in FIG. 3, the light guide substrate 11 is processed into a piece having a size, a thickness, and a shape suitable for an eyepiece. Even when the light guide substrate 11 is a single-layer substrate, an RGB light guide with a high FOV can be obtained. Thus, a thin and light-weight eyepiece can be provided.

### <Characteristics of Light Guide Element>

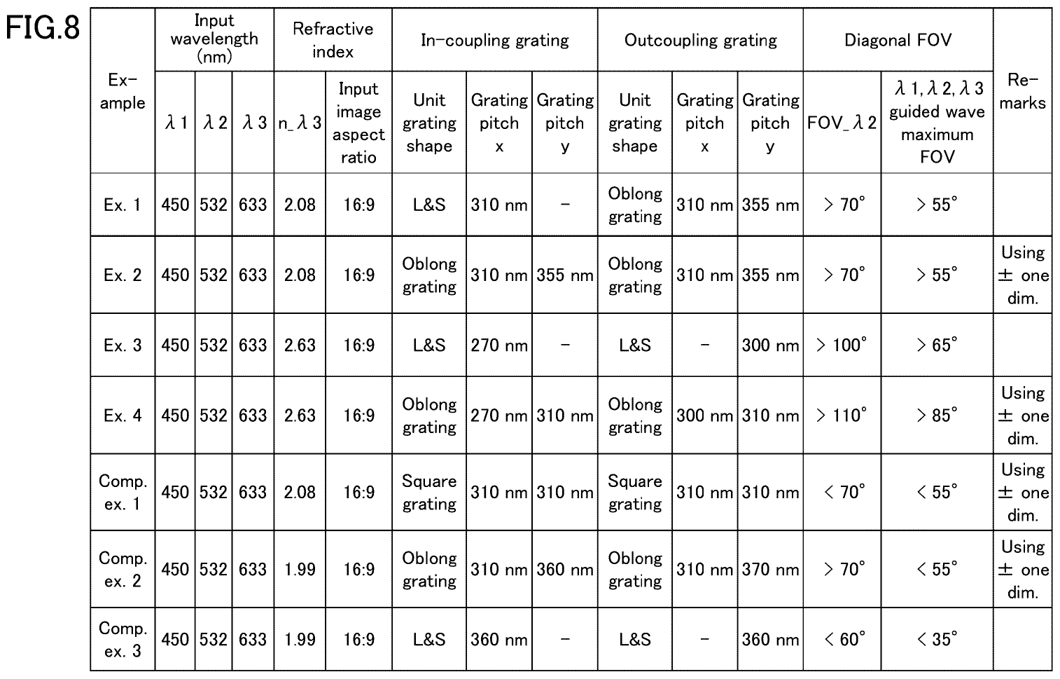

FIG. 8 shows shapes of grating and optical characteristics of light guide elements according to practical examples and comparative examples. The shape of grating includes the type of grating pattern and the grating pitch in the x- and y-directions. As the optical characteristics, specific values of the wavelengths λ1, λ2, and λ3, a value of the refractive index of the light guide substrate 11 at λ3, an aspect ratio in the x- and y-directions of an input image, and a value of the diagonal FOV are shown. A relationship between a tangent of the diagonal FOV, a tangent of the horizontal FOV, and a tangent of the vertical FOV is expressed by a relationship between a length of a diagonal line, a length of a side in the x-direction, and a length of a side in the y-direction with respect to the aspect ratio of a projected image. Assuming, for example, that an image having the aspect ratio of 4:3 is projected, the ratio among the tangents of the diagonal FOV, the horizontal FOV, and the vertical FOV is 5:4:3 ((4²+3²)^{1/2}=5). An annotation such as “using ±one-dimensional directions” is added to the configuration using diffractions in the positive and negative one-dimensional directions, as shown in FIG. 7B.

Throughout the practical examples and comparative examples, wavelengths of λ1 of 450 nm, λ2 of 532 nm, and λ3 of 633 nm are commonly used. The aspect ratio of the input image is 16:9. The diffraction layer 12 is formed of an inorganic film having a higher refractive index than that of the light guide substrate 11 at λ1, λ2, and λ3. Alternatively, the grating is formed directly on the light guide substrate 11. In these cases, because an occurrence of total internal reflection of the guided light is determined by the refractive index of the light guide substrate 11, it is not necessary to consider the refractive index of the diffraction layer 12 in the discussion of the viewing angle.

### EXAMPLES

### Example 1

A light guide element according to Example 1 includes the in-coupling grating 121 using a line-and-space pattern (denoted as “L&S” in FIG. 8); and the outcoupling grating 123 using a two-axis diffraction grating in which the unit grating is a rectangular grating. The grating pitch in the x-direction of the in-coupling grating 121 is 310 nm. The grating pitches in the x- and y-directions of the outcoupling grating 123 are 310 nm and 355 nm, respectively. The light guide substrate 11 is formed of Bi₂O₃—B₂O₃—TeO₂—P₂O₅—Nb₂O₅—ZnO glass. The specific composition of the glass (mol %) is Bi₂O₃:B₂O₃:TeO₂:P₂O₅:Nb₂O₅:ZnO=37.6:26.5:18.5:10.5:1.6:5.3.

The refractive index of the light guide substrate 11 in Example 1 at λ3 is 2.08. The shorter the wavelength, the greater the refractive index affecting the wave, so the refractive index for the d-line (wavelength is 587.56 nm) is greater than 2.08. The diagonal FOV at λ2 in Example 1 is greater than 70 degrees, and a maximum guiding FOV at all of λ1, λ2, and λ3 is greater than 55 degrees.

### Example 2

In Example 2, a two-axis diffraction grating, in which the unit grating is a rectangular grating, is used for both the in-coupling grating 121 and the outcoupling grating 123, and diffractions in the positive and negative one-dimensional directions are used. In each of the in-coupling grating 121 and the outcoupling grating 123, the grating pitch in the x-direction is 310 nm and the pitch in the y-direction is 355 nm. For the light guide substrate 11, a Bi₂O₃—B₂O₃—TeO₂—P₂O₅—Nb₂O₅—ZnO glass substrate of the same composition as in Example 1 is used. The refractive index of this light guide substrate 11 at λ3 is 2.08. The diagonal FOV at λ2 in Example 2 is greater than 70 degrees, and the maximum guiding FOV at all of λ1, λ2, and λ3 is greater than 55 degrees.

### Example 3

In Example 3, line-and-space patterns are used for both the in-coupling grating 121 and the outcoupling grating 123. The pitch of the in-coupling grating 121 in the x-direction is 270 nm, and the pitch of the outcoupling grating 123 in the y-direction is 300 nm. For the light guide substrate 11, a single-crystal substrate of SiC is used. The refractive index of this SiC substrate at λ3 is 2.63. The diagonal FOV at λ2 in Example 3 is greater than 100 degrees, and the maximum guiding FOV at all of λ1, λ2, and λ3 is greater than 65 degrees. By using the light guide substrate 11 with the large refractive index, a high FOV can be achieved while using a line-and-space diffraction grating.

### Example 4

In Example 4, a two-axis diffraction grating, in which the unit grating is a rectangular grating, is used for both the in-coupling grating 121 and the outcoupling grating 123. The in-coupling grating 121 has a pitch of 270 nm in the x-direction and a pitch of 310 nm in the y-direction. The outcoupling grating 123 has a pitch of 300 nm in the x-direction and a pitch of 310 nm in the y-direction. For the light guide substrate 11, a single-crystal substrate of SiC is used as in Example 3. The refractive index of the SiC substrate at λ3 is 2.63. The diagonal FOV at λ2 in Example 4 is greater than 110 degrees, and the maximum guiding FOV at all of λ1, λ2, and λ3 is greater than 85 degrees. In Example 4, a high FOV can be achieved by using the light guide substrate 11 having the high refractive index and the two-axis diffraction grating, in which the unit grating is a rectangular grating, for both the in-coupling grating 121 and the outcoupling grating 123.

### Comparative Example 1

In Comparative Example 1, the same light guide substrate 11 (refractive index is 2.08 at λ3) as in Examples 1 and 2 is used, but a two-axis diffraction grating, in which the unit grating is a square grating, is used for both the in-coupling grating 121 and the outcoupling grating 123. In each of the in-coupling grating 121 and the outcoupling grating 123, grating pitches in the x- and y-directions are 310 nm. Also in Comparative Example 1, diffractions in the positive and negative one-dimensional directions are used. In Comparative Example 1, the diagonal FOV at λ2 is less than 70 degrees, and the maximum guiding FOV at all of λ1, λ2, and λ3 is less than 55 degrees. Although the same light guide substrate 11 having the high refractive index as in Examples 1 and 2 is used, the diagonal FOV becomes smaller compared with Examples 1 to 3 by using the two-axis diffraction grating, in which the unit grating is a square grating, for an input image with an aspect ratio of 16:9.

### Comparative Example 2

In Comparative Example 2, lead-free and arsenic-free optical glass described in Japanese Patent No. 4970896 is used for the light guide substrate. The composition of this optical glass (mol %) is GeO₃:Bi₂O₃:B₂O₃:ZnO:SiO₂:Li₂O:BaO:Sb₂O₃=30.9:25.0:15.9:10.0:8.0:5.0:5.0:0.1.

The refractive index of the optical glass substrate of Comparative Example 2 at λ3 is 1.99, and the refractive index nd for the d-line is in the range of 1.91≤nd≤2.05. A two-axis diffraction grating, in which the unit grating is a rectangular grating, is used for both the in-coupling grating 121 and the outcoupling grating 123, and diffractions in the positive and negative one-dimensional directions are utilized. The pitch of the in-coupling grating 121 in the x-direction is 310 nm and the pitch in the y-direction is 360 nm. The pitch of the outcoupling grating 123 in the x-direction is 310 nm and the pitch in the y-direction is 370 nm. In Comparative Example 2, the diagonal FOV at λ2 exceeds 70 degrees, but the maximum guiding FOV at all of λ1, λ2, and λ3 is less than 55 degrees. Although a two-axis diffraction grating, in which the unit grating is a rectangular grating, is used for the in-coupling grating 121 and the outcoupling grating 123 and diffractions in the positive and negative one-dimensional directions are used, a high FOV cannot be achieved for all colors of RGB, because the refractive index at λ3 of the light guide substrate 11 is 1.99.

### Comparative Example 3

In Comparative Example 3, the same optical glass as in Comparative Example 2 is used. The refractive index of the light guide substrate at λ3 is 1.99, and the refractive index nd for the d-line is 1.91−2.05 (1.91≤nd≤2.05). In Comparative Example 3, a line-and-space pattern is used for both the in-coupling grating 121 and the outcoupling grating 123. The pitch of the in-coupling grating 121 in the x-direction is 360 nm, and the pitch of the outcoupling grating 123 in the y-direction is 360 nm. In Comparative Example 3, the diagonal FOV at λ2 is less than 60 degrees, and the maximum guiding FOV at all of λ1, λ2, and λ3 is less than 35 degrees. When the light guide substrate 11 with the refractive index nd of 2.05 or less for the d-line is used, and a line-and-space pattern is used for both the in-coupling grating 121 and the outcoupling grating 123, the FOV value required for the display apparatus 100 cannot be achieved.

From the results shown in FIG. 8, it is found that the refractive index nd for the d-line of the light guide substrate is preferably greater than 2.05. By using the light guide substrate 11 with the refractive index nd greater than 2.05, a high FOV can be achieved even when a line-and-space pattern is used for the in-coupling grating 121 and the outcoupling grating 123.

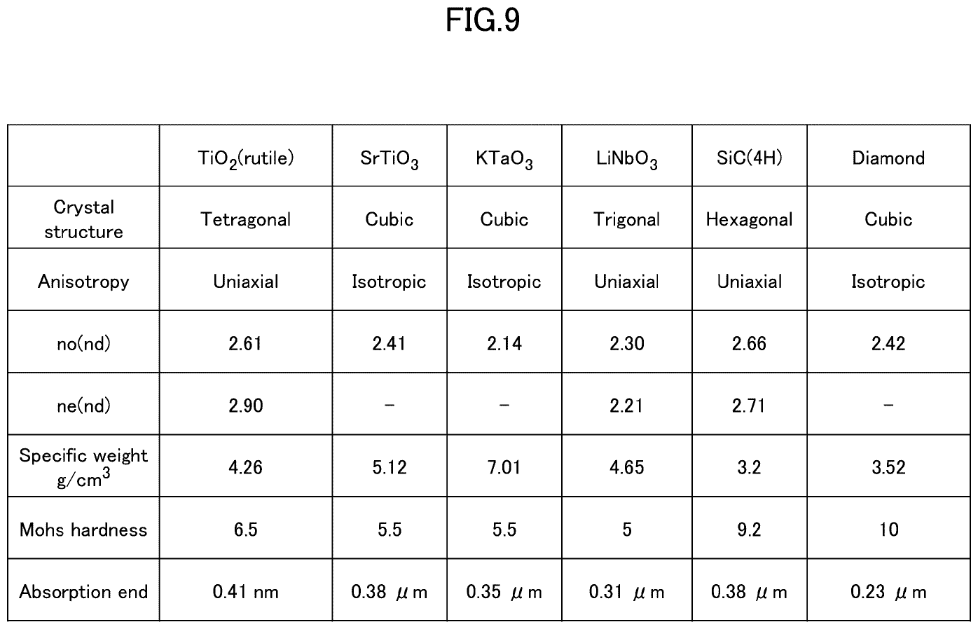

FIG. 9 shows an example of crystalline materials used for the light guide substrate 11. When a single crystal substrate is used for the light guide substrate 11, TiO₂, SrTiO₃, KTaO₃, LiNbO₃, SiC, diamond, or the like can be used. In addition to crystal structures of these materials, FIG. 9 shows for each material: presence or absence of optical anisotropy; an ordinary ray refractive index no at the d-line; an extraordinary ray refractive index ne at the d-line; specific gravity (g/cm³); Mohs hardness; and wavelength at absorption end.

Strontium titanate (SrTiO₃), potassium tantalite (KTaO₃), and diamond are optically isotropic. Titanium oxide (TiO₂), lithium niobate (LiNbO₃), and silicon carbide (SiC) are uniaxial and exhibit birefringence. However, the orientation of the optical axis with respect to the direction normal to the substrate is within ±4 degrees, and the reduction in resolution due to the generation of double images derived from the birefringence in viewing transmitted images of real images does not affect the FOV. In any of the crystals, an absorption edge resides in the ultraviolet region, and visible light is transmitted.

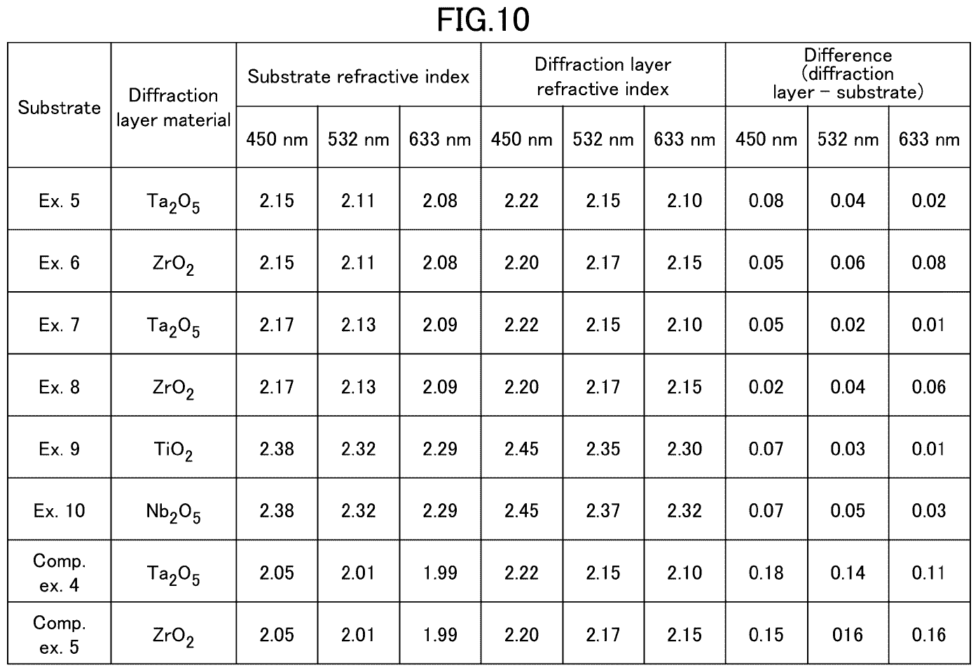

FIG. 10 shows a difference in refractive index between the light guide substrate and the diffraction layer in each of the practical examples and the comparative examples. The refractive index of the light guide substrate 11, the refractive index of the diffraction layer 12, and the difference in refractive index between the light guide substrate 11 and the diffraction layer 12 are shown for each of the wavelengths of 450 nm (λ1), 532 nm (λ2), and 633 nm (λ3). The refractive index for each wavelength is obtained from the refractive index nd for the d-line and the Abbe's number νd for the d-line, assuming a normal dispersion.

### Example 5

In Example 5, Ta₂O₅ is used for the diffraction layer 12. The light guide substrate 11 is a Bi₂O₃—B₂O₃—TeO₂—P₂O₅—Nb₂O₅—ZnO glass substrate used in Example 1 and Example 2. For each wavelength, the refractive index of the diffraction layer 12 is higher than the refractive index of the light guide substrate 11. The difference in refractive index is 0.08 for the wavelength of 450 nm, 0.04 for the wavelength of 532 nm, and 0.02 for the wavelength of 633 nm. Thus, any of the differences are less than 0.1.

### Example 6

In Example 6, ZrO₂ is used for the diffraction layer 12. The light guide substrate 11 is a Bi₂O₃—B₂O₃—TeO₂—P₂O₅—Nb₂O₅—ZnO glass substrate used in Example 1 and Example 2. For each wavelength, the refractive index of the diffraction layer 12 is higher than the refractive index of the light guide substrate 11. The difference in refractive index is 0.05 for the wavelength of 450 nm, 0.06 for the wavelength of 532 nm, and 0.08 for the wavelength of 633 nm. Thus, any of the differences are less than 0.1.

### Example 7

In Example 7, Ta₂O₅ is used for the diffraction layer 12. The light guide substrate 11 is a Bi₂O₃—TiO₂—Nb₂O₅—WO₃—B₂O₃—P₂O₅—SiO₂—BaO substrate. The specific composition of the light guide substrate 11 (mol %) is Bi₂O₃:TiO₂:Nb₂O₅:P₂O₅:WO₃:B₂O₃:BaO:SiO₂=21.0:18.5:16.5:22.6:14.5:2.8:2.8:1.6. For each wavelength, the refractive index of the diffraction layer 12 is higher than the refractive index of the light guide substrate 11. The difference in refractive index is 0.05 for the wavelength of 450 nm, 0.02 for the wavelength of 532 nm, and 0.01 for the wavelength of 633 nm. Thus, any of the differences are less than 0.1.

### Example 8

In Example 8, ZrO₂ is used for the diffraction layer 12. The light guide substrate 11 is a Bi₂O₃—TiO₂—Nb₂O₅—WO₃—B₂O₃—P₂O₅—SiO₂—BaO substrate used in Example 7 and has the same composition as in Example 7. For each wavelength, the refractive index of the diffraction layer 12 is higher than the refractive index of the light guide substrate 11. The difference in refractive index is 0.02 for the wavelength of 450 nm, 0.04 for the wavelength of 532 nm, and 0.06 for the wavelength of 633 nm. Thus, any of the differences are less than 0.1.

### Example 9

In Example 9, TiO₅ is used for the diffraction layer 12 and a single crystal substrate of LiNbO₃ is used for the light guide substrate 11. For each wavelength, the refractive index of the diffraction layer 12 is higher than the refractive index of the light guide substrate 11. The difference in refractive index is 0.07 for the wavelength of 450 nm, 0.03 for the wavelength of 532 nm, and 0.01 for the wavelength of 633 nm. Thus, any of the differences are less than 0.1.

### Example 10

In Example 10, Nb₂O₅ is used for the diffraction layer 12. The light guide substrate 11 is a LiNbO₃ single crystal substrate same as in Example 9. For each wavelength, the refractive index of the diffraction layer 12 is higher than the refractive index of the light guide substrate 11. The difference in refractive index is 0.07 for the wavelength of 450 nm, 0.05 for the wavelength of 532 nm, and 0.03 for the wavelength of 633 nm. Thus, any of the differences are less than 0.1.

### Comparative Example 4

In Comparative Example 4, Ta₂O₅ is used for the diffraction layer 12. The light guide substrate 11 is a lead-free and arsenic-free optical glass substrate disclosed in Japanese Patent No. 4970896 used in Comparative Example 2 and Comparative Example 3. With this combination, the refractive index of the diffraction layer 12 is high, but the refractive index of the light guide substrate 11 for each wavelength is 2.05 or less, and the difference in refractive index becomes large. The difference in refractive index is 0.18 for the wavelength of 450 nm, 0.14 for the wavelength of 532 nm, and 0.11 for the wavelength of 633 nm. Thus, any of the differences exceed 0.1.

### Comparative Example 5

In Comparative Example 5, ZrO₂ is used for the diffraction layer 12. As in Comparative Example 4, the light guide substrate 11 is a lead-free and arsenic-free optical glass substrate in Japanese Patent No. 4970896. Even with this combination, the refractive index of the diffraction layer 12 is high, but the refractive index of the light guide substrate 11 for each wavelength is 2.05 or less, and the difference in refractive index becomes large. The difference in refractive index is 0.15 for the wavelength of 450 nm, 0.16 for the wavelength of 532 nm, and 0.16 for the wavelength of 633 nm. Thus, any of the differences exceed 0.1.

When the refractive index of the diffraction layer 12 is lower than the refractive index of the light guide substrate 11, light with the Numerical Aperture (NA=n×sin(θ)), which is determined by a refractive index between the refractive index of the diffraction layer 12 and the refractive index of the light guide substrate 11, cannot be emitted from the light guide substrate 11 to the diffraction layer 12 and does not diffract. Therefore, the refractive index of the diffraction layer 12 at λ3 is required to be greater than the refractive index of the light guide substrate 11. On the other hand, when the difference, Δn, between the refractive index of the diffraction layer 12 and the refractive index of the light guide substrate 11 is large, reflection at an interface becomes large and the extraction efficiency at the outcoupling grating 123 decreases. Therefore, for the wavelengths of λ1, λ2, and λ3, the difference between the refractive index of the diffraction layer 12 and the refractive index of the light guide substrate 11 is preferably 0.1 or less (Δn≤0.1). In particular, for the wavelength of λ3, which performs total internal reflection guiding in the light guide substrate 11 at a large reflection angle, Δn is preferably smaller than 0.1, because influence of interface reflection becomes large. At λ3, Δn is more preferably smaller than 0.05, and even more preferably smaller than 0.03. When the differences in refractive indices at λ1, λ2, and λ3 are denoted by Δnλ1, Δnλ2, and Δnλ3, the influence from the interface reflection is easily reduced for all wavelengths in the case where Δnλ1?Δnλ2?Δnλ3. In many cases, for the wavelengths λ1 and λ2, it is possible to perform the total internal reflection light guiding in a desired FOV even when the refractive index of the diffraction layer 12 is lower than the refractive index of the light guide substrate 11. Therefore, a combination of materials may be selected such that the materials have a lower dispersion than the dispersion of the light guide substrate 11 and the refractive index of the light guide substrate 11 and the diffraction layer 12 match each other for a wavelength shorter than λ3.

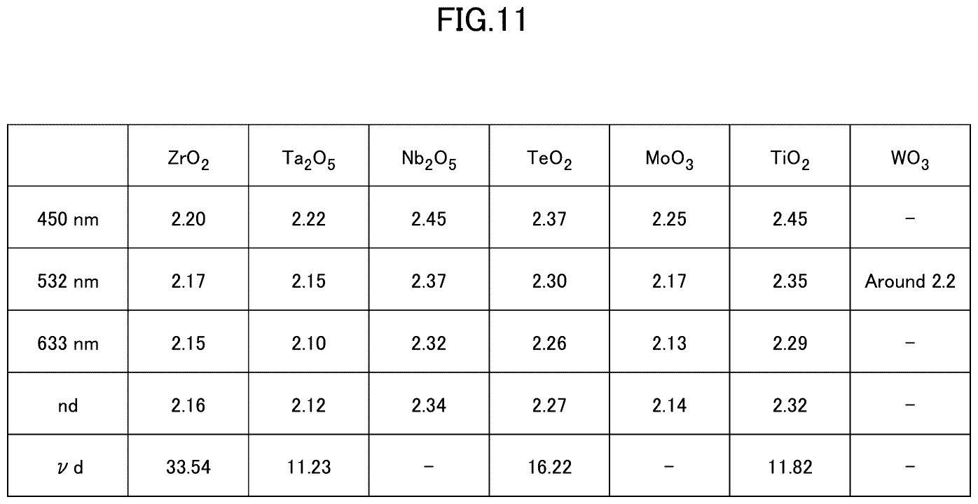

FIG. 11 shows properties of materials used for the diffraction layer 12. As described above, in order to outcouple light to the outside of the light guide substrate 11, the refractive index of the diffraction layer 12 is set to be greater than or equal to the refractive index of the light guide substrate 11. As the material of the diffraction layer 12, for example, ZrO₂, Ta₂O₅, Nb₂O₅, TeO₂, MoO₃, TiO₂, or WO₃ may be used. Other than the above-described materials, materials having a high refractive index, such as HfO₂, SiN, SiON, SnO, ITO (indium tin oxide), Al₂O₃, Y₂O₃, AlN, or MgO, may also be used depending on the material of the light guide substrate 11.

The refractive index for each wavelength is obtained from the refractive index nd for the d-line and the Abbe's number νd for the d-line, in the same manner as in FIG. 10. The larger the Abbe's number, the lower the chromatic aberration. In the example of FIG. 11, any of the materials have the refractive index nd greater than 2.10. When the light guide substrate 11 with the refractive index nd greater than 2.05 is used, the material of the diffraction layer 12 can be selected from the materials shown in FIG. 11 appropriately according to the refractive index of the light guide substrate 11.

### <Design of FOV>

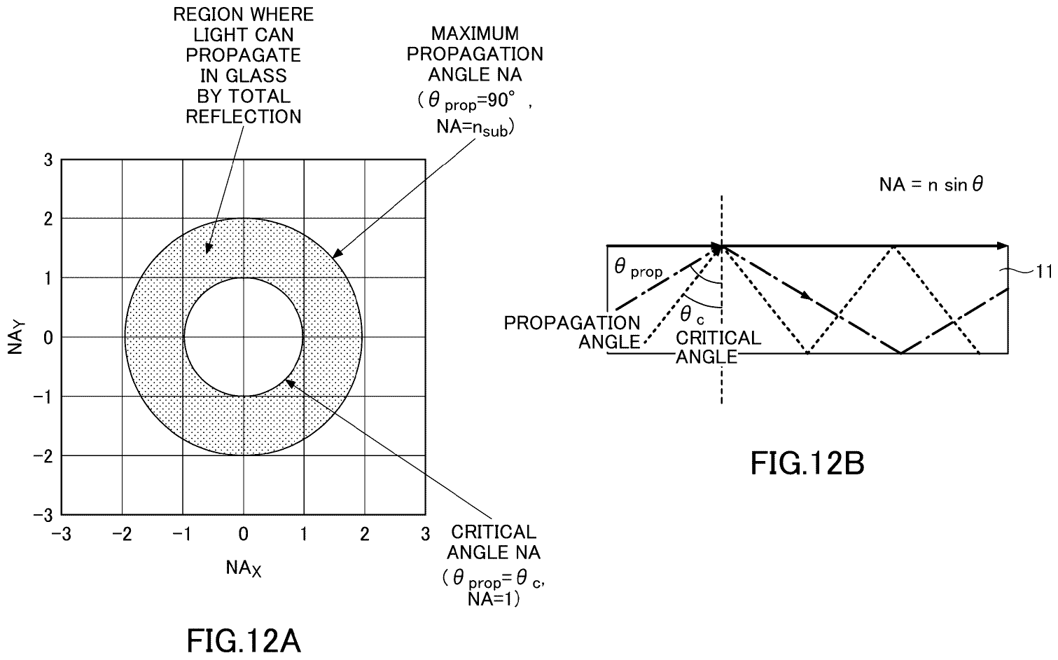

FIGS. 12A to 14B are diagrams illustrating a design of a NA (Numerical Aperture) diagram and a FOV. FIG. 12A shows the NA diagram with the horizontal axis representing a numerical aperture in the x-direction NAx and the vertical axis representing a numerical aperture in the y-direction NAy. The donut-shaped region between an inner circle and an outer circle is a region where light can propagate by total internal reflection in the light guide substrate 11. The inner circle represents the NA at the critical angle, and the outer circle represents the NA at the maximum propagation angle.

FIG. 12B is a diagram depicting a propagation state in the light guide substrate 11. The numerical aperture NA is expressed as n×sin(θ). The incident angle of light propagating by total internal reflection at the interface is denoted by θₚᵣₒₚ. The critical angle at which total internal reflection occurs at the interface is denoted by θ_{c}. The inner circle of the NA diagram represents the NA when θₚᵣₒₚ=θ_{c}. When the numerical aperture NA in this case is set to 1 (NA=1), the inner circle is a circle with a radius of 1.

In the outer circle, θₚᵣₒₚ is 90 degrees (θₚᵣₒₚ=90 degrees). The radius of the outer circle is determined by the refractive index n of the light guide substrate 11. Therefore, the higher the refractive index of the light guide substrate 11, the wider the outer circle and the wider the range of an angle in which the total internal reflection guiding can be performed.

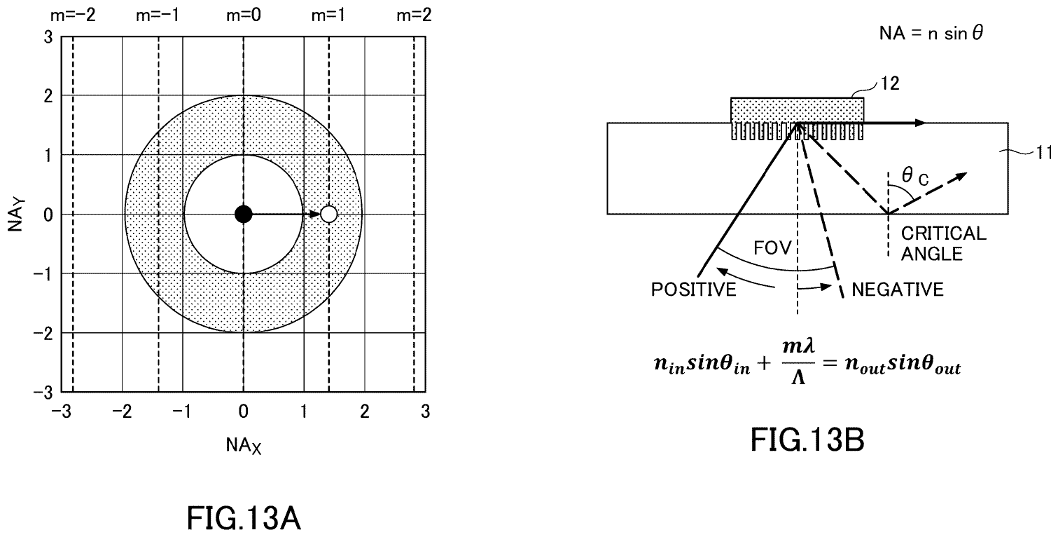

In FIG. 13A, the black circle in the center of the NA diagram is the numerical aperture NA (or incident angle) of light incident on the in-coupling grating 121. The white circle at the end of the arrow extending from the black circle in the right direction represents the NA of light emitted from the outcoupling grating 123. The arrow between the black circle and the white circle indicates the NA that varies with diffraction. The diffraction of the totally internally reflected guided light emitted from the outcoupling grating 123 is the first order diffraction (m=1).

With reference to FIG. 13B, a right part with respect to a normal to the diffraction layer 12 is defined to be a positive NA, and a left part with respect to the normal is defined to be a negative NA. The angular region between the positive NA and the negative NA is the FOV. In the light guide element 10 of the embodiment, the FOV is 55 degrees or more for any of λ1, λ2, and λ3. When the pitch of the diffraction grating is denoted by Λ, the wavelength is denoted by λ, and the diffraction order is denoted by m, the incident angle on the in-coupling grating 121 and the emission angle from the outcoupling grating 123 have a relation of

nᵢₙ×sin(θᵢₙ)+mλ/Λ=nₒᵤₜ×sin(θₒᵤₜ).

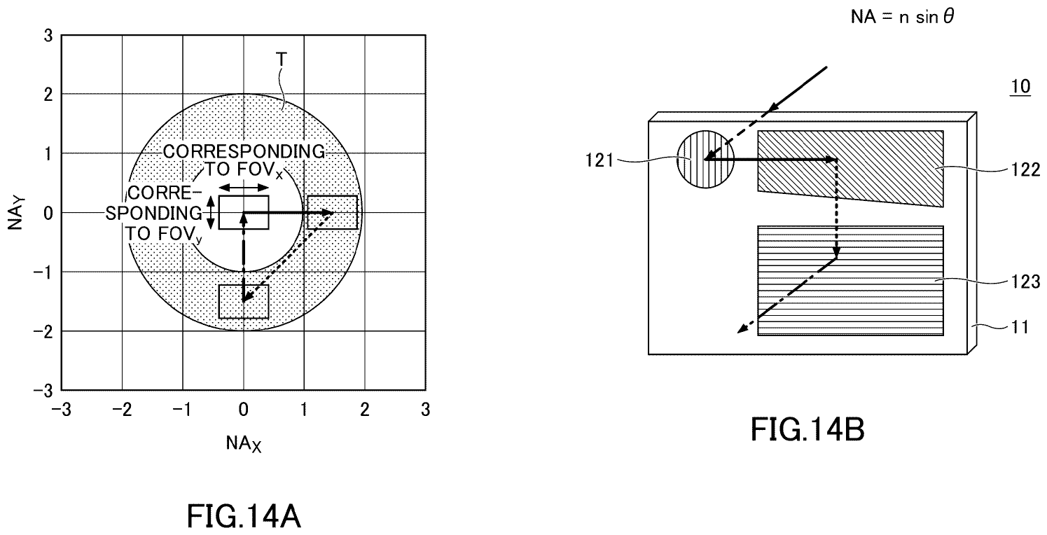

FIGS. 14A and 14B are diagrams illustrating designing the light guide element in which the incident FOV and the emission FOV are made the same. A rectangle at the center of the NA diagram shown in FIG. 14A is a NA area corresponding to the incident FOV. The horizontal side of the rectangle corresponds to the FOV in the x-direction (FOVx), and the vertical side corresponds to the FOV in the y-direction (FOVy). Strictly speaking, an image of a rectangular field of view has a barrel shape inscribed in the above-mentioned rectangle on the NA diagram. However, for convenience, a rectangular representation will be substituted. The diagonal FOV corresponds to the FOV at the diagonal of this rectangle. Light incident in this FOV is guided by being diffracted several times within the doughnut-shaped total internal reflection propagation region T, and returned to the original position.

With reference to FIG. 14B, the light incident on the central NA area in FIG. 14A is coupled into the light guide substrate 11 by the in-coupling grating 121, redirected by the extended grating 212, and propagated to the outcoupling grating 123 while totally internally reflecting in the light guide substrate 11. The totally internally reflected propagating light is emitted by the outcoupling grating 123 in the emission FOV, which is the same as the incident FOV.

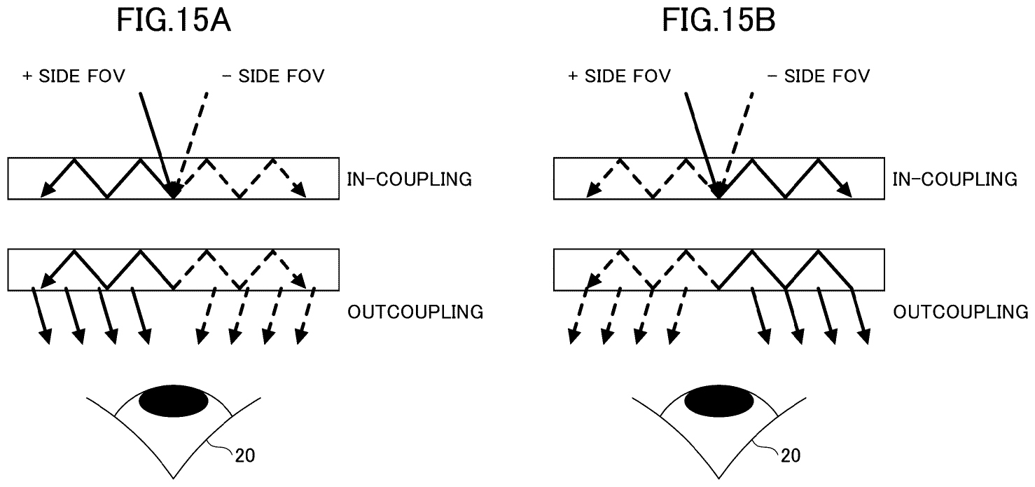

FIGS. 15A and 15B are diagrams illustrating the positive and negative one-dimensional diffraction guiding direction and visibility. When the incident FOV and the emission FOV are made the same as shown in FIGS. 14A and 14B, light of the incident angle corresponding to the FOV on the positive side is in-coupled in the direction opposite to the propagating direction, as shown in FIG. 15A. When the totally internally reflected propagating light is emitted at the same angle as the incident angle by the outcoupling grating 23, the light is emitted in the direction toward the user's eye 20. Similarly, the light of the incident angle corresponding to the FOV on the negative side is in-coupled in the direction opposite to the propagating direction. The light emitted at the same angle as the incident angle by the outcoupling grating is directed toward the user's eye 20. Thus, image visibility is excellent.

On the other hand, when light of the incident angle corresponding to the FOV on the positive side is in-coupled in the propagating direction, as shown in FIG. 15B, light emitted by the outcoupling grating 123 does not enter the user's eye 20. The same applies to the FOV on the negative side, and the image visibility is degraded. Therefore, when the incident FOV and the emission FOV are made the same, the in-coupling grating 121 and the outcoupling grating 123 are designed so that light is diffracted in the direction to maximize the image visibility.

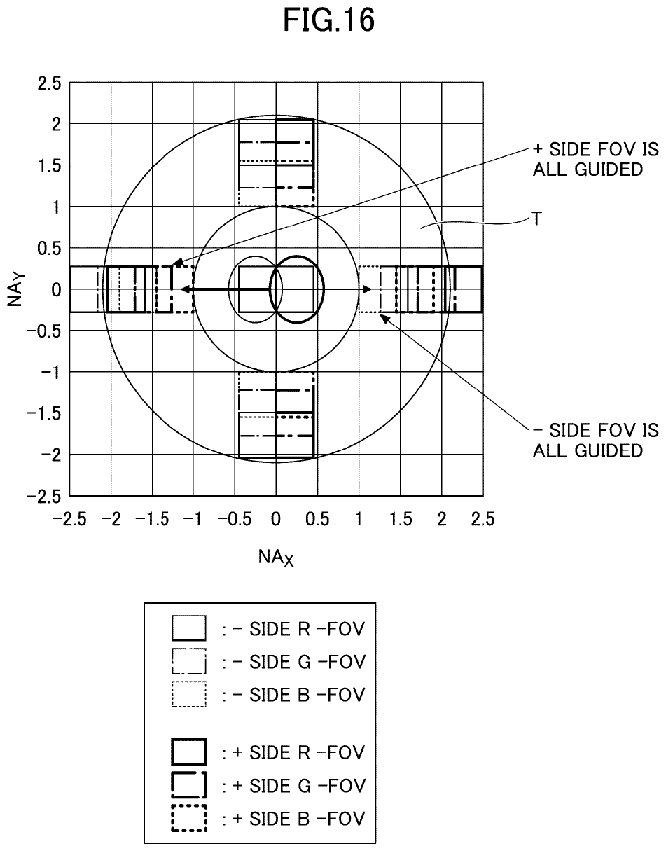

FIG. 16 is a diagram illustrating an effect of expanding the FOV by utilizing diffraction in the positive and negative one-dimensional direction. In this example, diffractions in the +x- and −x-directions are considered. In the NA diagram, the positive side FOV is indicated by thick lines and the negative side FOV is indicated by thin lines. The solid lines indicate the FOV of R light, the dotted lines indicate the FOV of G light, and the dotted lines indicate the FOV of B light.

Light corresponding to the positive side FOV of each of the colors of RGB is guided in the total internal reflection propagation region T on the left side of the NA diagram. Light corresponding to the negative side FOV of each of the colors of RGB is guided in the total internal reflection propagation region T on the right side of the NA diagram. Because there is a direction in which light corresponding to the FOV of each of the colors of RGB can be guided, an occurrence of vignetting is suppressed. Thus, the expansion effect of the FOV is obtained by using diffractions in the positive and negative one-dimensional directions. For example, by using a light guide substrate with the refractive index of 2.08 at λ3, a diagonal FOV of 55 degrees or more can be achieved for any of λ1, λ2, and λ3 included in RGB.

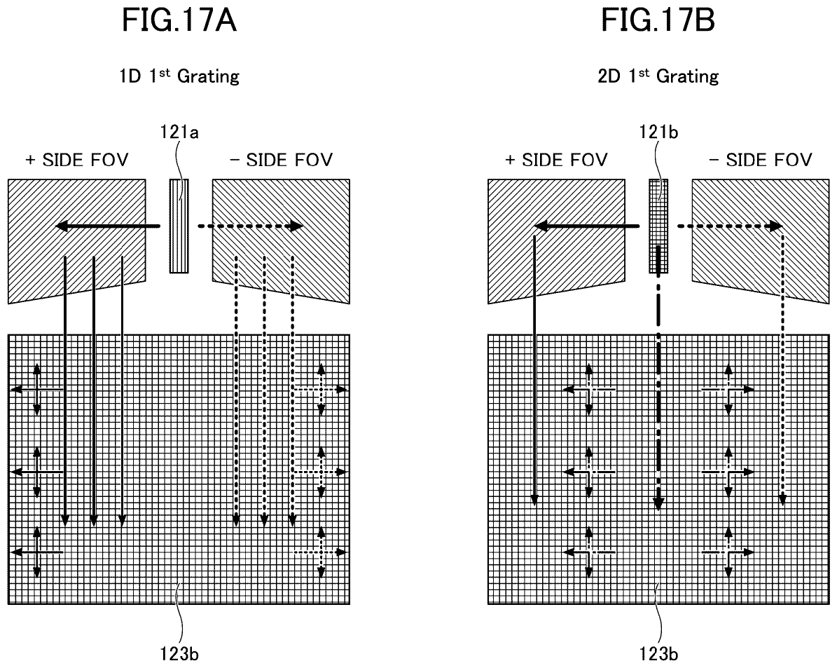

FIGS. 17A and 17B are diagrams illustrating an effect by using a two-axis diffraction grating in which the unit grating is a rectangular grating, for the in-coupling grating. FIG. 17A shows that when the in-coupling grating 121a having a line-and-space type one-dimensional pattern is used, light of the positive side FOV diffracted to the left side in the drawing is guided to the left side of the outcoupling grating 123b, and light of the negative side FOV diffracted to the right side in the drawing is guided to the right side of the outcoupling grating 123b. In the case where the outcoupling grating 123b is a two-axis diffraction grating in which the unit grating is a rectangular grating, in the outcoupling grating 123b light is diffracted in the up, down, left, or right direction. Thus, light is subjected to the two-dimensional diffraction guiding by the outcoupling grating 123b. However, regarding light to enter the center of the outcoupling grating 123b, the light may not be in-coupled with the in-coupling grating 121a, and as a result, the light guiding may be insufficient in the central part of the outcoupling grating 123b.

FIG. 17B is a diagram illustrating an example, using a two-axis diffraction grating, in which the unit grating is a rectangular grating, for the in-coupling grating 121b. FIG. 17B shows that light diffracted from the in-coupling grating 121b and guided in the direction to the outcoupling grating 123b occurs. Thus, all the FOVs, including the positive side FOV and negative side FOV, perform the waveguide of the central part of the light guide substrate. The amount of light of an image emitted from the outcoupling grating 123b is made uniform, to improve the visibility. By using a blazed grating for the two-axis diffraction grating, the diffraction efficiency of light diffracted to the side of the outcoupling grating 123b can be selectively enhanced, so that the utilization efficiency of incident light can be improved.

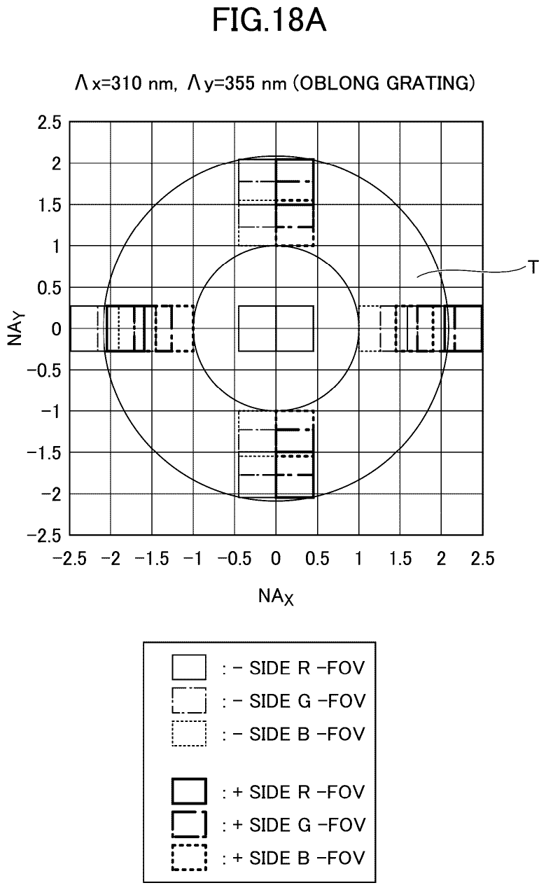

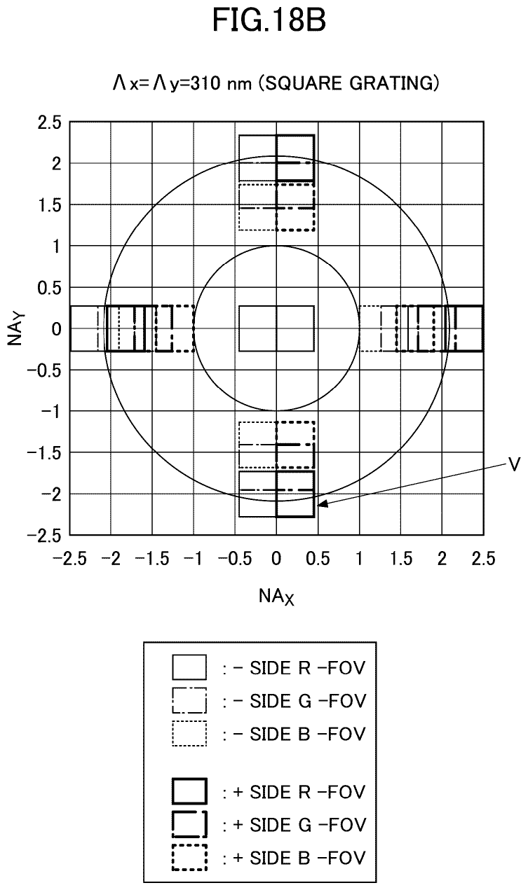

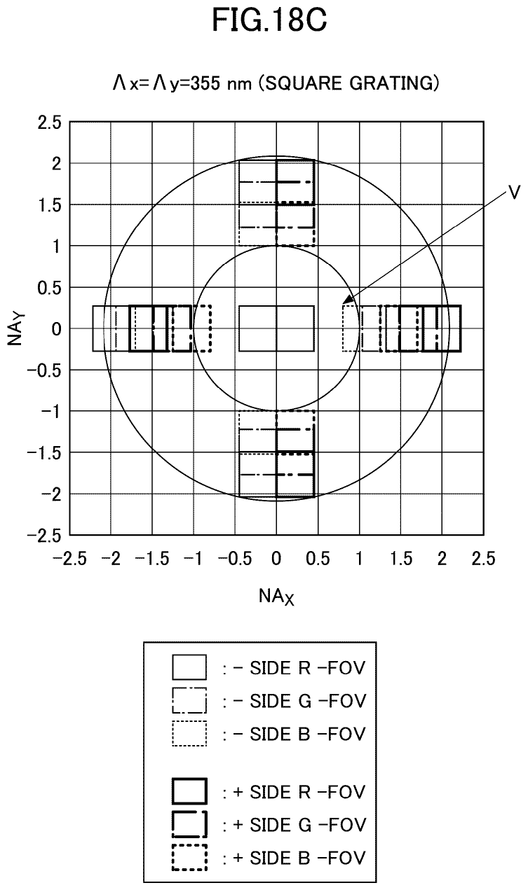

FIG. 18A is a diagram illustrating an effect of using a two-axis diffraction grating, in which the unit grating is a rectangular grating. The grating pitch in the x-direction is 310 nm and the grating pitch in the y-direction is 355 nm. Of the central incident FOVs of the NA diagram, FOVs of the right side part are the positive side FOVs in the x-direction and FOVs of the left side part are the negative side FOVs in the x-direction. The positive side FOVs are in the left side part of the NA diagram, where light with each wavelength of RGB propagates within the total internal reflection propagation region T. The negative side FOVs are in the right side part of the NA diagram, where light with each wavelength of RGB propagates within the total internal reflection propagation region T.

Also in the +y and −y-directions, light with each wavelength of RGB propagates within the total internal reflection propagation region T. Thus, an occurrence of vignetting is suppressed. Using a light guide substrate 11 that is a single-layer light guide substrate with the refractive index of 2.08 at λ3, the diagonal FOV of 55 degrees or more for each wavelength of RGB can be obtained.

FIGS. 18B and 18C are diagrams depicting examples of the FOV light guide when using a two-axis diffraction grating, in which the unit grating is a square grating. In FIG. 18B, the grating pitch in the x- and y-directions is 310 nm. In FIG. 18C the grating pitch in the x- and y-directions is 355 nm. In FIG. 18B, in the vertical direction, i.e., y-direction, of the NA diagram, R light is not sufficiently subjected to the total internal reflection light guiding, and vignetting (indicated by “V”) occurs. In FIG. 18C, in the horizontal direction, i.e., x-direction, of the NA diagram, both in the positive side FOV and the negative side FOV, B light is not sufficiently subjected to the total internal reflection light guiding, and vignetting (V) occurs. Thus, by using the two-axis diffraction grating, in which the unit grating is a rectangular grating, as shown in FIG. 18A, an occurrence of vignetting is suppressed, and quality of color images can be maintained.

According to the above description, it is possible to design an optical element having the FOV of 55 degrees or more for each wavelength of RGB and excellent visibility, in the case of projecting an image where an aspect ratio of a projected image is Ax:Ay, when the refractive index of the light guide substrate 11 at λ3 is n_λ3, at least the outcoupling grating is a two-axis diffraction grating, in which the unit grating is a rectangular grating, and a pitch in the x-direction, Λx, and a pitch in the y-direction, Λy, of the rectangular grating satisfy the following relations, where
the diagonal FOV is denoted by FOVdiag;
the horizontal positive side FOV is denoted by FOVx+ (sign is positive):
the horizontal negative side FOV is denoted by FOVx− (sign is positive);
the vertical positive side FOV is denoted by FOVy+; and
the vertical negative side FOV is denoted by FOVy−.

1≤λ1/Λx−sin(FOVx−)

(λ3/Λx)²+sin(FOVy+)²≤(n_λ3)²

(λ3/Λx)²+sin(FOVy−)²≤(n_λ3)² (1)

1≤λ1/Λx−sin(FOVx+)

(λ3/Λx)²+sin(FOVy+)²≤(n_λ3)²

(λ3/Λx)²+sin(FOVy−)²≤(n_λ3)² (2)

1≤λ1/Λy−sin(FOVy+)

λ3/Λy+sin(FOVy−)≤(n_λ3)

(λ3/Λy+sin(FOVy−))²+sin(FOVx+)²≤(n_λ3)²

(λ3/Λy+sin(FOVy−))²+sin(FOVx−)²≤(n_λ3)² (3)

tan(((FOVx+)+(FOVx−))/2)=Ax/(Ax²+Ay²)^{1/2}·tan(FOVdiag/2) (4)

tan(((FOVy+)+(FOVy−))/2)=Ay/(Ax²+Ay²)^{1/2}·tan(FOVdiag/2) (5)

FOVdiag≥55 degrees (6)

### <FOV Characteristics of Example 1>

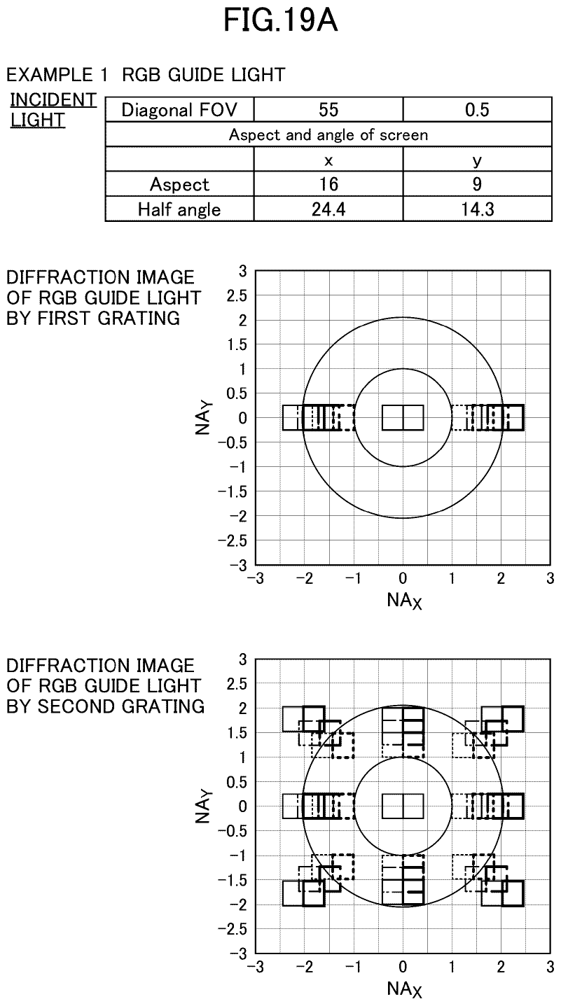

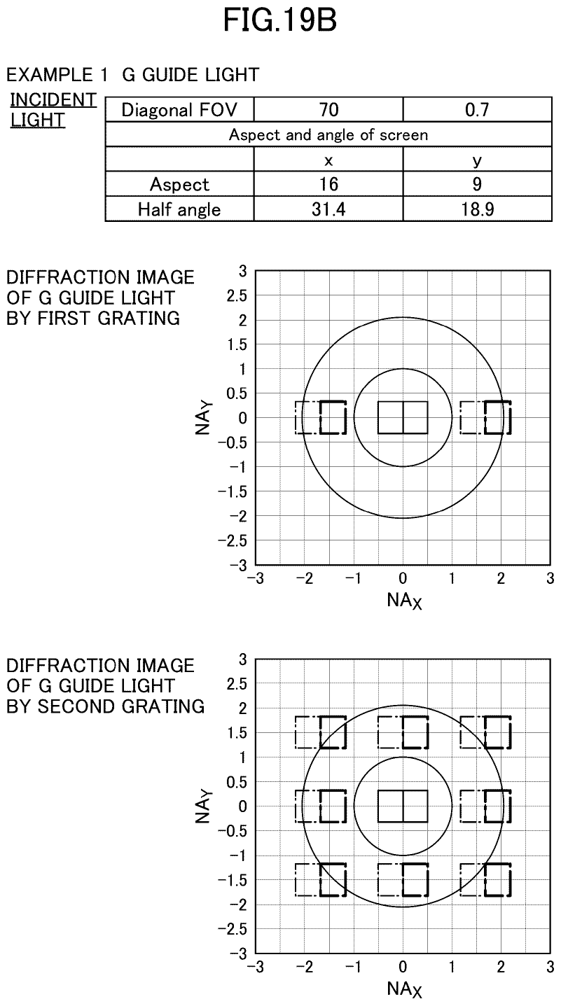

FIG. 19A is a diagram showing characteristics and diffraction patterns of the RGB light guiding of Example 1. FIG. 19B is a diagram showing characteristics and diffraction patterns of the G light guiding of Example 1. The type and the pitch of the diffraction grating of Example 1 and the refractive index of the light guide substrate 11 for each wavelength are as shown in FIG. 8. In the RGB light guiding shown in FIG. 19A, the diagonal FOV of incident light is 55 degrees, a visual field ratio is 0.5, and an aspect ratio of an incident image is 16:9. A half-angle in the x-direction is 24.4 degrees, and a half-angle in the y-direction is 14.3 degrees.

The middle figure in FIG. 19A is a NA diagram showing a diffraction pattern for RGB light incident normal to the in-coupling grating 121 (denoted by “first grating” in the drawing). The lower figure in FIG. 19A is a NA diagram showing a diffraction pattern for RGB light incident normal to the outcoupling grating 123 (denoted by “second grating” in the drawing). The first grating is a one-axis diffraction grating having a line-and-space pattern, and the second grating is a two-axis diffraction grating, in which the unit grating is a rectangular grating. In the diffraction pattern of the first grating, light corresponding to the positive side FOV diffracts into the left side part of the total internal reflection propagation region, and light corresponding to the negative side FOV diffracts into the right side part of the total internal reflection propagation region.

In the diffraction pattern of the second grating, light with each wavelength of RGB diffracts into the total internal reflection propagation region in the ±x-directions and in the ±y-directions. The grating pitch of the in-coupling grating 121 and the grating pitch of the outcoupling grating 123 are set so that the diffraction is performed in the NA diagrams shown in FIG. 19A. With the above-described grating design, RGB images without vignetting can be reproduced in the diagonal FOV of 55 degrees using the light guide substrate 11 that is a single-layer light guide substrate.

In the G light guiding of FIG. 19B, the diagonal FOV for incident light is 70 degrees, the visual field ratio is 0.7, and the aspect ratio of the incident image is 16:9. The half-angle in the x-direction is 31.4 degrees, and the half-angle in the y-direction is 18.9 degrees.

The middle figure in FIG. 19B is a NA diagram showing a diffraction pattern for G light incident normal to the in-coupling grating 121 (denoted by “first grating” in the drawing). The lower figure in FIG. 19B is a NA diagram showing a diffraction pattern for G light incident normal to the outcoupling grating 123 (denoted by “second grating” in the drawing). In the diffraction pattern of the first grating having a line-and-space pattern, light corresponding to the positive side FOV diffracts into the left side part of the total internal reflection propagation region (thick dot-dash quadrangle), and light corresponding to the negative side FOV diffracts into the right side part of the total internal reflection propagation region (thin dot-dash quadrangle).

In the diffraction pattern of the second grating, which is a two-axis diffraction grating, in which the unit grating is a rectangular grating, G light diffracts into the total internal reflection propagation region in the ±x-directions and in the ±y-directions. It is possible to expand the FOV for G light using the light guide substrate 11 that is a single-layer light guide substrate with the above-described configuration of grating. However, even when R light or B light is incident normal to the second grating in the diagonal FOV of 70 degrees, total internal reflection light guiding is not necessarily achieved in both the ±x-directions and the ±y-directions.

<FOV characteristics of Example 2>

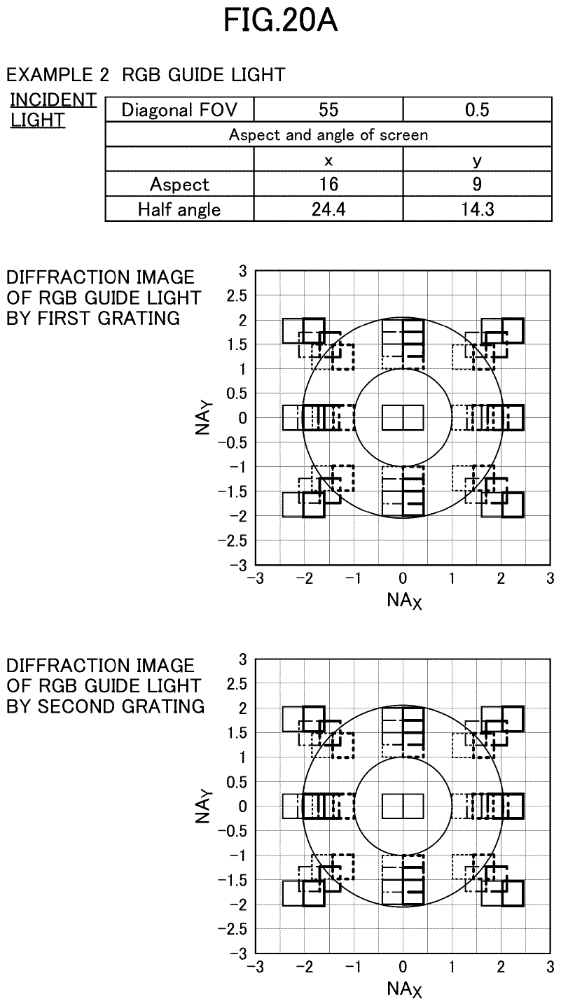

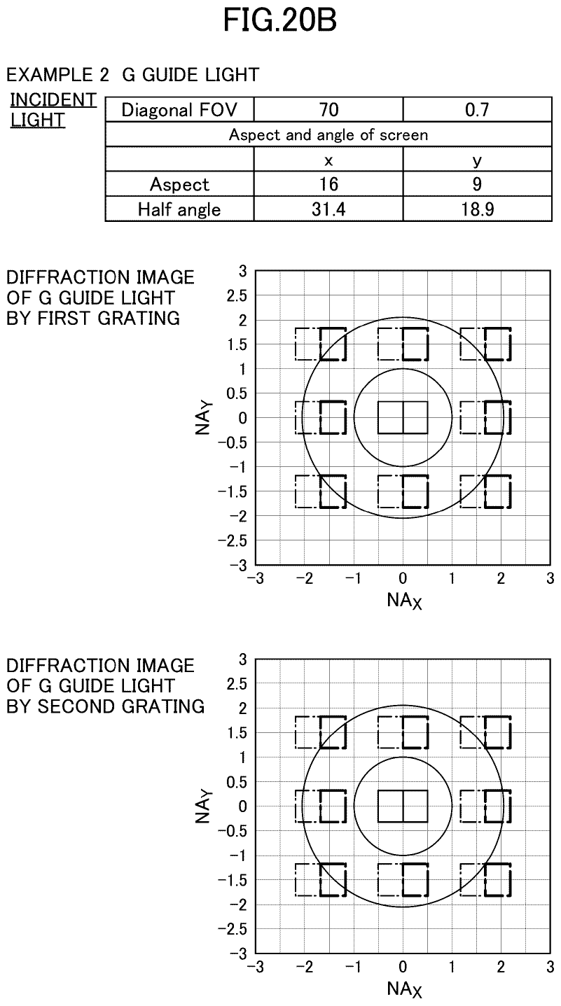

FIG. 20A is a diagram showing characteristics and diffraction patterns of the RGB light guiding of Example 2. FIG. 20B is a diagram showing characteristics and diffraction patterns of the G light guiding of Example 2. The type and the pitch of the diffraction grating of Example 2 and the refractive index of the light guide substrate 11 for each wavelength are as shown in FIG. 8. In the RGB light guiding shown in FIG. 20A, the diagonal FOV of incident light is 55 degrees, a visual field ratio is 0.5, and an aspect ratio of an incident image is 16:9. A half-angle in the x-direction is 24.4 degrees, and a half-angle in the y-direction is 14.3 degrees.

The middle figure in FIG. 20A is a NA diagram showing a diffraction pattern for RGB light incident normal to the in-coupling grating 121 (denoted by “first grating” in the drawing). The lower figure in FIG. 20A is a NA diagram showing a diffraction pattern for RGB light incident normal to the outcoupling grating 123 (denoted by “second grating” in the drawing). Both the first grating and the second grating are two-axis diffraction gratings in which the unit grating is a rectangular grating.

In the diffraction pattern of the first grating, in the x-axis direction, light corresponding to the positive side FOV diffracts into the left side part of the total internal reflection propagation region, and light corresponding to the negative side FOV diffracts into the right side part of the total internal reflection propagation region. In the y-axis direction, light with each wavelength of RGB corresponding to all the FOVs diffracts into the total internal reflection propagation region. Also in the diffraction pattern of the second grating, light with each wavelength of RGB diffracts into the total internal reflection propagation region in the ±x-directions and in the ±y-directions. The grating pitch of the in-coupling grating 121 and the grating pitch of the outcoupling grating 123 are set so that the diffraction is performed in the NA diagrams shown in FIG. 20A. With the above-described grating design, RGB images without vignetting can be reproduced in the diagonal FOV of 55 degrees using the light guide substrate 11 that is a single-layer light guide substrate.

In the G light guiding of FIG. 20B, the diagonal FOV for incident light is 70 degrees, the visual field ratio is 0.7, and the aspect ratio of the incident image is 16:9. The half-angle in the x-direction is 31.4 degrees, and the half-angle in the y-direction is 18.9 degrees.

The middle figure in FIG. 20B is a NA diagram showing a diffraction pattern for G light incident normal to the in-coupling grating 121 (denoted by “first grating” in the drawing). The lower figure in FIG. 20B is a NA diagram showing a diffraction pattern for G light incident normal to the outcoupling grating 123 (denoted by “second grating” in the drawing). In the diffraction pattern of the first grating, in which the unit grating is a rectangular grating, G light diffracts into the total internal reflection propagation region in the ±x-directions and in the ±y-directions.

Also in the diffraction pattern of the second grating, in which the unit grating is a rectangular grating, G light diffracts into the total internal reflection propagation region in the ±x-directions and in the ±y-directions. It is possible to expand the FOV for G light using the light guide substrate 11 that is a single-layer light guide substrate. However, even when R light or B light is incident normal to the second grating in the diagonal FOV of 70 degrees, total internal reflection light guiding is not necessarily achieved in both the ±x-directions and the ±y-directions.

### <FOV Characteristics of Example 3>

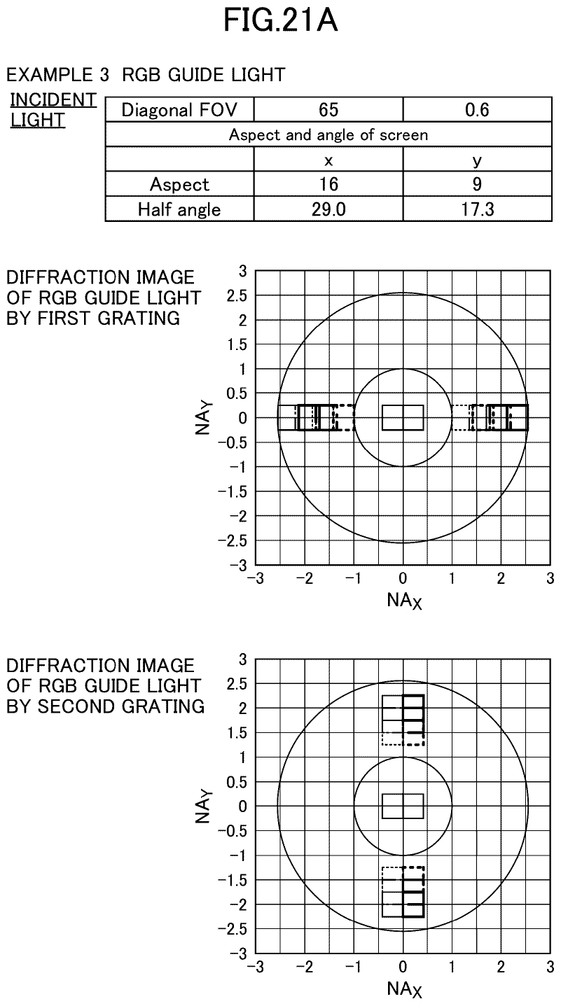

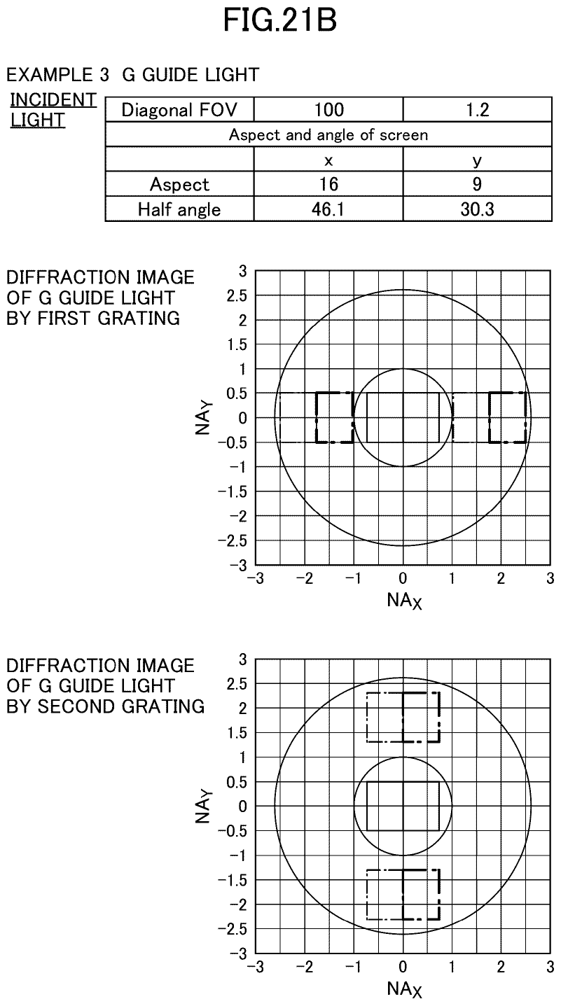

FIG. 21A is a diagram showing characteristics and diffraction patterns of the RGB light guiding of Example 3. FIG. 21B is a diagram showing characteristics and diffraction patterns of the G light guiding of Example 3. The type and the pitch of the diffraction grating of Example 3 and the refractive index of the light guide substrate 11 for each wavelength are as shown in FIG. 8. In the RGB light guiding shown in FIG. 21A, the diagonal FOV of incident light is 65 degrees, a visual field ratio is 0.6, and an aspect ratio of an incident image is 16:9. A half-angle in the x-direction is 29.0 degrees, and a half-angle in the y-direction is 17.3 degrees.

The middle figure in FIG. 21A is a NA diagram showing a diffraction pattern for RGB light incident normal to the in-coupling grating 121 (denoted by “first grating” in the drawing). The lower figure in FIG. 21A is a NA diagram showing a diffraction pattern for RGB light incident normal to the outcoupling grating 123 (denoted by “second grating” in the drawing). Both the first grating and the second grating are one-axis diffraction gratings each having line-and-space pattern. However, the extension direction of the grating pattern in the first grating is orthogonal to the extension direction of the grating pattern in the second grating.

In the diffraction pattern of the first grating, light with each wavelength of RGB corresponding to the incident FOV diffracts into the total internal reflection propagation region in the +x-direction and the −x-direction. In the diffraction pattern of the second grating, light with each wavelength of RGB corresponding to the incident FOV diffracts into the total internal reflection propagation region in the +y-direction and the −y-direction. The grating pitch of the in-coupling grating 121 and the grating pitch of the outcoupling grating 123 are set so that the diffraction is performed in the NA diagrams shown in FIG. 21A. Using the light guide substrate 11 that is a single-layer light guide substrate and the one-axis diffraction grating with the line-and-space pattern, RGB images without vignetting can be reproduced in the diagonal FOV of 65 degrees.

In the G light guiding shown in FIG. 21B, the diagonal FOV of incident light is 100 degrees, a visual field ratio is 1.2, and an aspect ratio of an incident image is 16:9. A half-angle in the x-direction is 46.1 degrees, and a half-angle in the y-direction is 30.3 degrees.

The middle figure in FIG. 21B is a NA diagram showing a diffraction pattern for G light incident normal to the in-coupling grating 121 (denoted by “first grating” in the drawing). The lower figure in FIG. 21B is a NA diagram showing a diffraction pattern for G light incident normal to the outcoupling grating 123 (denoted by “second grating” in the drawing). In the diffraction pattern of the first grating of the line-and-space type, both light corresponding to the positive side FOV and light corresponding to the negative side FOV diffract into the total internal reflection propagation region in the ±x-directions. In the diffraction pattern of the second grating, both light corresponding to the positive side FOV and light corresponding to negative side FOV diffract into the total internal reflection propagation region in the ±y-directions. It is possible to expand the diagonal FOV to 100 degrees for G light using the light guide substrate 11 that is a single-layer light guide substrate. However, even when R light or B light is incident normal to the second grating in the diagonal FOV of 100 degrees, total internal reflection light guiding is not necessarily achieved in both the ±x-directions and the ±y-directions.

### <FOV Characteristics of Example 4>

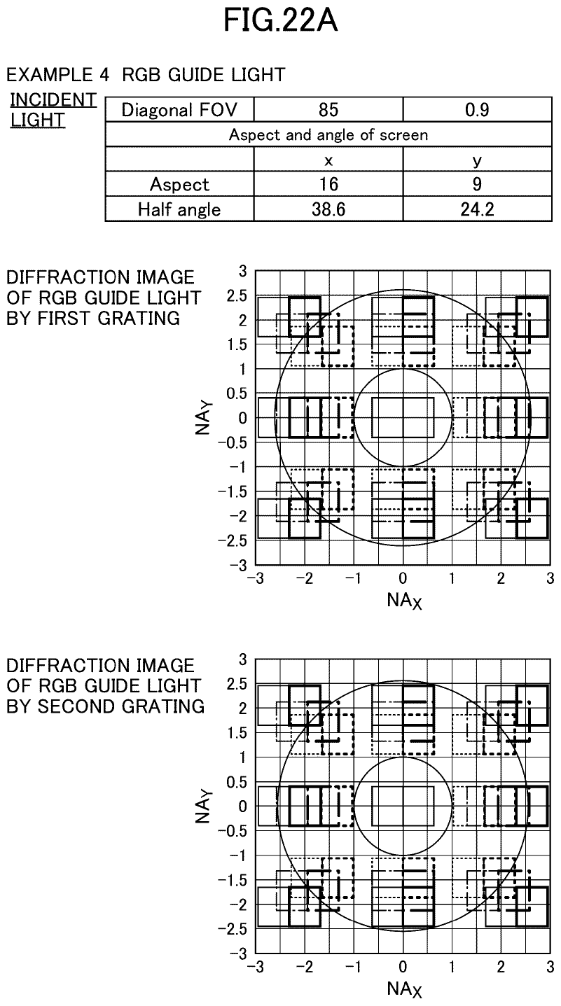

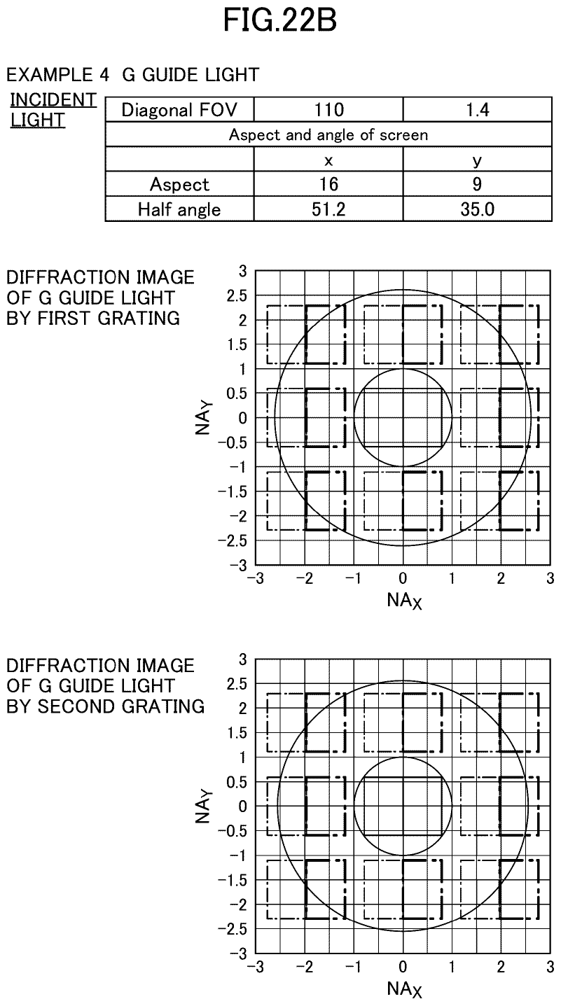

FIG. 22A is a diagram showing characteristics and diffraction patterns of the RGB light guiding of Example 4. FIG. 22B is a diagram showing characteristics and diffraction patterns of the G light guiding of Example 4. The type and the pitch of the diffraction grating of Example 4 and the refractive index of the light guide substrate 11 for each wavelength are as shown in FIG. 8. In the RGB light guiding shown in FIG. 22A, the diagonal FOV of incident light is 85 degrees, a visual field ratio is 0.9, and an aspect ratio of an incident image is 16:9. A half-angle in the x-direction is 38.6 degrees, and a half-angle in the y-direction is 24.2 degrees.

The middle figure in FIG. 22A is a NA diagram showing a diffraction pattern for RGB light incident normal to the in-coupling grating 121 (denoted by “first grating” in the drawing). The lower figure in FIG. 22A is a NA diagram showing a diffraction pattern for RGB light incident normal to the outcoupling grating 123 (denoted by “second grating” in the drawing). Both the first grating and the second grating are two-axis diffraction gratings in which the unit grating is a rectangular grating. In the diffraction pattern of the first grating, in the x-axis direction, light corresponding to the positive side FOV diffracts into the left side part of the total internal reflection propagation region, and light corresponding to the negative side FOV diffracts into the right side part of the total internal reflection propagation region. In the y-axis direction, light with each wavelength of RGB corresponding to all the FOVs diffracts into the total internal reflection propagation region.

Also in the diffraction pattern of the second grating, light with each wavelength of RGB diffracts into the total internal reflection propagation region in the ±x-directions and in the ±y-directions. The grating pitch of the in-coupling grating 121 and the grating pitch of the outcoupling grating 123 are set so that the diffraction is performed in the NA diagrams shown in FIG. 22A. With the above-described grating design, RGB images without vignetting can be reproduced in the diagonal FOV of 85 degrees using the light guide substrate 11 that is a single-layer light guide substrate.

In the G light guiding shown in FIG. 22B, the diagonal FOV for incident light is 110 degrees, the visual field ratio is 1.4, and the aspect ratio of the incident image is 16:9. The half-angle in the x-direction is 51.2 degrees, and the half-angle in the y-direction is 35.0 degrees.

The middle figure in FIG. 22B is a NA diagram showing a diffraction pattern for G light incident normal to the in-coupling grating 121 (denoted by “first grating” in the drawing). The lower figure in FIG. 22B is a NA diagram showing a diffraction pattern for G light incident normal to the outcoupling grating 123 (denoted by “second grating” in the drawing). In the diffraction pattern of the first grating, in which the unit grating is a rectangular grating, G light diffracts into the total internal reflection propagation region in the ±x-directions and in the ±y-directions.

Also in the diffraction pattern of the second grating, which is a two-axis diffraction grating, in which the unit grating is a rectangular grating, G light diffracts into the total internal reflection propagation region in the ±x-directions and in the ±y-directions. It is possible to expand the diagonal FOV for at least G light to 110 degrees using the light guide substrate 11 that is a single-layer light guide substrate. However, even when R light or B light is incident normal to the first grating or the second grating in the diagonal FOV of 110 degrees, total internal reflection light guiding is not necessarily achieved in both the ±x-directions and the ±y-directions.

As described above, the present invention has been described based on the specific configuration examples. However, the present invention is not limited to the above-described examples. Various variations, modifications, substitutions, additions, deletions, and combinations are possible within the scope of claims. They also of course fall within the technical scope of the present disclosure. The display apparatus 100 using the light guide element 10 may be linked with a smartphone, a laptop personal computer (PC), or the like. The display screen of the smartphone or the laptop PC may be set to have a working field of view with the diagonal FOV of 55 degrees, and set to have an indirect field of view with the diagonal FOV of 70 degrees or more around the working field of view. In this case, a simple monochromatic image or information may be displayed in the indirect field of view within a range that does not interfere with daily activities.

What is claimed is:

1. A light guide element comprising:
a light guide substrate that is a single-layer light guide substrate; and
a diffraction layer formed on the light guide substrate,
wherein the diffraction layer includes
a first diffraction grating configured to in-couple light into the light guide substrate, the light being incident on the light guide substrate, and
a second diffraction grating configured to outcouple totally internally reflected light having propagated in the light guide substrate out of the light guide substrate,
wherein the first diffraction grating in-couples the incident light in a range of 60 degrees or more including a direction normal to the light guide substrate, for at least one wavelength of a first wavelength included in a 450 nm±20 nm band, a second wavelength included in a 530 nm±20 nm band, and a third wavelength included in a 630 nm±20 nm band, and
wherein the second diffraction grating outcouples the totally internally reflected light in a range of 60 degrees or more including the direction normal to the light guide substrate, for at least one wavelength of the first wavelength, the second wavelength, and the third wavelength.

2. The light guide element according to claim 1,
wherein the first diffraction grating in-couples the incident light, for any of the first wavelength, the second wavelength, and the third wavelength, in a common range of 55 degrees or more including the direction normal to the light guide substrate, and
wherein the second diffraction grating outcouples the totally internally reflected light, for any of the first wavelength, the second wavelength, and the third wavelength, in a common range of 55 degrees or more including the direction normal to the light guide substrate.

3. The light guide element according to claim 1,
wherein an internal transmittance per 10 mm thickness of the light guide substrate in light with a wavelength of 450 nm is 95% or more.

4. The light guide element according to claim 1,
wherein the light guide substrate is
an isotropic single crystal substrate, or
a uniaxial crystal substrate having an optical axis, an angle formed between the optical axis and the direction normal to the light guide substrate being within ±4 degrees.

5. The light guide element according to claim 1,
wherein a refractive index of the light guide substrate for the d-line is greater than 2.05.

6. The light guide element according to claim 1,
wherein the light guide substrate is a glass substrate, a glass material of the glass substrate being:
(1) Bi₂O₃—TeO₂ based glass, containing 20% to 50% of Bi₂O₃ and 10% to 35% of TeO₂; or
(2) La₂O₃—B₂O₃ based glass, containing 10% to 40% of La₂O₃ and 10% to 35% of B₂O₃,
the total composition being 100% by mole % in terms of oxide.

7. The light guide element according to claim 1,
wherein the light guide substrate contains 20% or more of Bi₂O₃, and 55% or more of Bi₂O₃—TeO₂—Nb₂O₅—TiO₂—Ta₂O₅—WO₃, when the total composition is 100% by mole % in terms of oxide.

8. The light guide element according to claim 1,
wherein the light guide substrate is a substrate of TiO₂, SrTiO₃, KTaO₃, LiNbO₃, SiC, or diamond.

9. The light guide element according to claim 1,
wherein the diffraction layer is formed of ZrO₂, HfO₂, Ta₂O₅, Nb₂O₅, TeO₂, MoO₃, WO₃, TiO₂, SiN, SiON, SnO, ITO, Al₂O₃, Y₂O₃, AlN, MgO, or a mixture of two or more thereof.

10. The light guide element according to claim 9,
wherein a refractive index of the diffraction layer for the third wavelength is greater than a refractive index of the light guide substrate for the third wavelength, and
wherein a difference between the refractive index of the diffraction layer for the third wavelength and the refractive index of the light guide substrate for the third wavelength is 0.1 or less.

11. The light guide element according to claim 1,
wherein the second diffraction grating is a two-axis diffraction grating, in which a unit grating is a rectangular grating, and
wherein the second diffraction grating has a grating pitch so that when light of the first wavelength, the second wavelength, or the third wavelength is incident normal to the second diffraction grating from the light guide substrate, light diffracted in positive and negative one-dimensional directions along an x-axis or in positive and negative one-dimensional directions along a y-axis total internal reflection is guided to be totally internally reflected in the light guide substrate for any wavelength of the first wavelength, the second wavelength, and the third wavelength.

12. The light guide element according to claim 1,
wherein the second diffraction grating is a two-axis diffraction grating, in which a unit grating is a rectangular grating, and
wherein the second diffraction grating has a grating pitch so that when light of any one of the first wavelength, the second wavelength, and the third wavelength is incident normal to the second diffraction grating from the light guide substrate, light diffracted in positive and negative one-dimensional directions along an x-axis and in positive and negative one-dimensional directions along a y-axis total internal reflection is guided to be totally internally reflected in the light guide substrate.

13. The light guide element according to claim 1,
wherein the first diffraction grating is a two-axis diffraction grating, in which a unit grating is a rectangular grating, and
wherein the first diffraction grating has a grating pitch so that when light of the first wavelength, the second wavelength, or the third wavelength is incident normal to the first diffraction grating from the light guide substrate, light diffracted in positive and negative one-dimensional directions along an x-axis or in positive and negative one-dimensional directions along a y-axis total internal reflection is guided to be totally internally reflected in the light guide substrate for any wavelength of the first wavelength, the second wavelength, and the third wavelength.

14. The light guide element according to claim 1,
wherein the first diffraction grating is a two-axis diffraction grating, in which a unit grating is a rectangular grating, and
wherein the first diffraction grating has a grating pitch so that when light of any one of the first wavelength, the second wavelength, and the third wavelength is incident normal to the first diffraction grating from the light guide substrate, light diffracted in positive and negative one-dimensional directions along an x-axis and in positive and negative one-dimensional directions along a y-axis total internal reflection is guided to be totally internally reflected in the light guide substrate.

15. A display apparatus comprising:
the light guide element according to claim 1; and
a projector,
wherein light projected from the projector is incident on the light guide element, and emitted from the second diffraction grating.
